(19) United States
(12) Patent Application Publication
(10) Pub. No.: US 2013/0346309 A1
(43) Pub. Date: Dec. 26, 2013

(54) SYSTEM AND METHOD FOR PROVIDING AND TRANSFERRING FUNGIBLE ELECTRONIC MONEY

(71) Applicant: Roberto Giori, Monaco (MC)

(72) Inventor: Roberto Giori, Monaco (MC)

(21) Appl. No.: 14/003,131

(22) PCT Filed: Mar. 6, 2012
(86) PCT No.: PCT/EP12/53821

§ 371 Date: Sep. 17, 2013

(51) Int. Cl. G06Q 20/10

(52) U.S. Cl. CPC G06Q 20/1085
USPC 705/43; 705/44

(57) ABSTRACT

A system and method for transferring fungible electronic money is disclosed. The system and method include two or more Central Banks that guarantee the electronic money within an electronic communications network, the electronic money being an authenticated and fungible currency capable of electronic transfer. The system and method further include registering a first user within the electronic services network, registering a second user within the electronic services network, receiving a request from the first user to transfer at least a portion of the electronic money to the second user, and electronically transferring the at least a portion of the electronic money to a mobile device belonging to the second user in response to the request received from the first user, wherein the electronic transfer occurs within the electronic communications network.

### FIELD OF THE INVENTION

The present invention relates generally to a system and method for providing fungible electronic money in a global “open loop” system instead of the more commonly and currently used “closed loop” system. More particularly, the present invention relates to a system and method for providing fungible electronic money that can be exchanged between parties, nationally and internationally, as freely as banknotes but while providing the appropriate oversight for controlling and regulating its flow. The supervision and control of such a system is preferably undertaken by Central Banks and/or by specific institutions. The present invention relates to the creation of a new government resource and global standard which will not only include the generation of codes at the Central Bank level designed to progressively substitute banknotes (or paper money), but will also incorporate the highest levels of secure encryption and means of transmission, and data compression, leveraging the latest in mobile technology, and which will lead to the establishment of globally issued guidelines and protocols correlated to the issuance of digital money.

### BACKGROUND OF THE INVENTION

On a daily basis, money is exchanged between parties (i.e., persons and/or entities) for basic necessities such as food, transportation, receiving goods and services, and even newspapers. Over the past decade, such exchanges have been gradually shifting toward electronic payment systems. As a result, the breadth of the types of exchanges that can be effected has also evolved, and it has become common practice to use such exchanges for such things as paying salaries, settling business transactions, and supporting one's family abroad.

For the past two decades, most of those transactions have primarily occurred through traditional banking systems and Money Transfer Operators (MTOs), both of which rely on a conventional financial infrastructure and framework to execute those transactions (e.g., the infrastructure and framework of the Society for Worldwide Interbank Financial Telecommunication (SWIFT) system). While that conventional financial infrastructure and framework provides an effective system for businesses, travelers, and even students abroad to exchange money, it is not available or accessible everywhere to everyone, such as people in rural communities in developing nations or immigrants in diaspora communities throughout the world.

That is because such conventional financial infrastructures and frameworks utilize “closed loop” systems that do not allow transfers outside of that loop. Moreover, some of those “closed loop” systems include structural weaknesses and loopholes that leave them vulnerable to abuses, such as money laundering and financing terrorist activities or illegal immigration.

An example of three closed loop systems are MTO systems (e.g., WESTERN UNION and MONEYGRAM brand MTO systems), mobile money systems (e.g., M-PESA and CELPAY brand mobile money systems), and internet payment systems (e.g., the PAYPAL brand internet payment system, the PAYPOINT brand internet payment system, etc.). MTO systems form a closed loop because parties can only send and receive money to and from the various entities (e.g., commercial banks, supermarkets, check cashers, convenience stores, etc.) with which an MTO has an agency relationship. And although a certain degree of success has been achieved by cellular service providers and their customers, mobile money systems also form a closed loop because parties can only send and receive money to and from other customers of the same cellular service provider and the entities (e.g., banks, retailers, agents, local service providers, etc.) that have partnered with that cellular service provider. Similarly, internet payment systems only allow parties to send and receive money when both parties have an account with the provider of that system. Accordingly, the ability to transfer funds via one of those three closed loop systems is limited by the ability of both parties (i.e., the sending party and the receiving party) to access one of the entities within those closed loop systems and/or to establish an account with the provider of those closed loop systems. The virtual currency networks such as BITCOIN and others, also generate e-money in closed loop networks. They, too, are trying to establish a presence in the marketplace but none of the known virtual currencies is transferable outside their respective frameworks, nor are they authenticated by a governing authority or the like.

The problem with such closed loop systems is seen most clearly in mobile money systems. In such systems, the sending party must deposit the money to be transferred with his or her cellular service provider. And that deposited money can only be transferred via the cellular service provider to a receiving party that has agreed to receive such transfers (i.e., other customers of the cellular service provider and businesses that have partnered with the cellular service provider). Accordingly, outside of the closed loop of customers and businesses with which the cellular service provider has contracted, the money deposited with the cellular service provider is not fungible. Instead, it exists only as a “pseudo-currency”, or “mobile scrip”, that only has value within that closed loop of customers and businesses, much like the coal mine scrip issued to coal miners in the United States during the 1900s.

Because such mobile scrip can only be used within a cellular service provider's closed loop of customers and businesses, its usefulness is not only limited to the entities within that closed loop, it is also limited to the geographic area serviced by that cellular service provided. More specifically, a cellular service provider is unlikely to have customers or partner with businesses outside of the geographic area it services. Accordingly, conventional mobile transfers are ill-suited for transferring money internationally.

International money transfers, typically in the form of formal remittances, make up a large portion of the types of money transfers made in developing countries. For example, it is estimated that there are currently over 30 million people from the African diaspora sending nearly $40 billion back to their families and communities by various methods of money transfer, with that number increasing every year. And although MTO systems are well suited for such international transfers, they often are not accessible in such developing countries as they are primarily located in large urban areas and are only occasionally dispersed throughout smaller communities. More specifically, a party in a rural area is not likely to have access to any of the entities in an MTO system where money can be received.

Because access to official channels of money transfer is often difficult to obtain, or even non-existent, less than 50% of money transfers, or remittances, occur through official channels. Instead, they occur via informal, unregulated channels such as the criminal organizations and criminal rackets that operate outside the law. Widely popular and frequently used, such systems operate as follows: a customer gives money to a hawala broker or individual in one city that is intended for a recipient in another city; a phone call is made to a broker in the recipient's city to provide disposition instructions in the recipient's city, minus a small commission; the transaction is made entirely based on the honor system without exchanging promissory instruments; a running tally of the amount owed by one broker to another is kept and debts are settled at a later date between those brokers, generally without the actual transfer of money. Out of necessity and due to lack of access to official banking systems, those and other similar informal channels are used by immigrants to provide money to their families at home. The deposited money and commissions are gathered by brokers or centers and accumulate in large, untraceable amounts that circulate underground in-country within the black market. Accordingly, the money being circulated via such channels is not only unregulated, it cannot be tracked or intercepted, which leads to potential abuses, such as money laundering, terrorist financing, drug trafficking, human trafficking, and trafficking of other contraband.

Not only are those informal channels of money transfer subject to abuse, so are some of the formal channels, such as MTO systems. MTO systems are subject to abuse because information beyond the details of the transaction is often not required to make such transfers, making them completely anonymous and untraceable. And even when identifying information is obtained by MTOs, there is no way to verify the validity of that information. Accordingly, although money transfers made by MTOs can actually be tracked, it is difficult to identify with any certainty who is sending and who is receiving the money being transferred. An example in which an official channel (i.e., MTO systems) and an unofficial channel were subject to abuse was the financing of the 2006 deadly attacks in Mumbai. As that example illustrates, the unmonitored and uncontrolled flow of money helps fuel criminal enterprises. The identification of the person who is sending money by using informal channels (e.g., the hawala system) is not possible, nor is the identification of the individuals undertaken with great accuracy in existing official money transfer channels thus rendering surveillance ineffective.

Additionally, an immigrant who uses informal organizations takes the risk that these organizations may use their profit for financing risky or illegal activities, which may have a direct impact on the economic stability of a country.

Because of the limited nature of the closed loop systems currently utilized to transfer money, there is a need to form an “open loop” system that integrates the various closed loop systems so that money can be transferred or transmitted between those systems. More specifically, there is a need for a global system that provides fungible money, rather than scrip, that can be transferred from one entity to another as freely as banknotes. And because many of the systems currently utilized to transfer money are subject to serious abuses, there is also a need for a system that tracks those transfers and who is making them. More specifically, there is a need for a system that provides watchdog functionality for identifying suspect transactions and suspect entities making those transactions. Moreover, there is a need for an open loop system with watchdog functionality that is efficient, reliable, affordable, and accessible so that entities will be encouraged to use that system instead of informal, unregulated channels.

### SUMMARY OF THE INVENTION

Consequently, an object of the invention is to propose a novel method for generating fungible electronic money and the creation of a worldwide standard in the issuance of digital currency that will act as a replacement or substitute for banknotes or paper money.

Another object of the present invention is to furnish a novel system of codes, the highest level of encryption and encoding, a means for systems integration and security at the government and/or Central Bank level for providing fungible electronic money.

Additionally, an object of the present invention is to function as a government resource aimed at designing protocols and establishing an architecture that incorporates appropriate hardware, software and encryption technology that functions with any Central Bank in the world.

Accordingly, it is also an object of the invention to provide an open loop system and method for transferring fungible electronic money that functions similar to the international banking network. With the international banking network, national payment systems that can be accessed from another country through correspondent banking allow payments and funds to be sent from any bank with cross-border services to any other bank in the world. The current invention operates in much the same way. It is a system and method that includes two or more Central Banks communicating with each other and guaranteeing electronic, fungible money in the financial framework. With that guarantee, or backing, there is protection for the end user in the event of a default by one of the operators in this field and money will still be available to the recipient. In addition, oversight is provided by a various watchdog agencies that, together with the Central Banks, can offer scrutiny and control of the flow of money. Those and other objects, advantages, and features of the present invention will become more readily apparent by the following written description, taken in conjunction with the accompanying drawings and claims.

The given objects to the invention are achieved with the help of a method for generating fungible electronic money for an open looped system, comprising the steps of:

collecting physical and/or numeric parameters of an existing bank note,
using a first algorithm for generating a first code based on at least some of the collected parameters,
using a numbering algorithm for generating a code number,
combining the first code with the code number and generating a unique second code which integrates data of the collected parameters,
and attributing the second code to an electronic/digital bank note.

The fungible electronic money can be used in any existing open loop financial system and can be exchanged in any other existing currency. This digital money would be known as Giori-money and would be an interchangeable or fungible instrument of currency in the general population.

Such electronic money will be very useful for immigrants and unbanked populations. In an implementation in accordance with the invention, the method comprises the step of using a first algorithm which generates a random code.

The method in accordance with the invention gives foreign workers the possibility to send money within their country and/or abroad, in an extremely secured way and for very low costs.

The digital money, called Giori-money can, for instance, be stored on a device such as a mobile phone.

In an implementation in accordance with the invention, the method comprises the step of using a numbering algorithm which generates unique and random code number which is combined to the first code.

In an implementation in accordance with the invention, the method comprises the step of storing the second code on a readable support within a safe environment.

In an implementation in accordance with the invention, the method comprises the step of using the second code for the identification of an electronic/digital bank note and for the authentication of a numeric transfer of electronic money.

Any other association or combination of the above mentioned steps may also be envisaged in the frame of the method in accordance with the invention.

The given objects to the invention are also achieved with the help of a system for carrying out the method mentioned above, in order to provide fungible electronic money, said system comprising:

means for collecting by reading or scanning physical and/or numeric parameters of an existing banknote, a banknote specimen and/or of any numeric data source,
software means in which is stored the first algorithm,
additional software means in which is stored the second algorithm,
and readable safe means for storing the second code.

In a preferred embodiment, the collected parameters can either result in a banknote specimen which is used in classical paper banknote production line or in any digital/numeric source such as CAD means. Alternatively, physical parameters can also result of scanning means of paper banknote sheets.

Any combination of reading and/or scanning means can also be envisaged within the frame of the invention, in order to collect the needed parameters.

In an embodiment in accordance with the invention, the system comprises communication means for establishing data communication between official controlling authorities and electronic transaction systems and/or communication/banking networks, for supervising and controlling any transaction using electronic money.

The given objects to the invention are also achieved with the help of an open loop method for transferring fungible electronic money:

two or more Central Banks guaranteeing the electronic money within an electronic communications network, the electronic money being an authenticated and fungible currency capable of electronic transfer;
registering a first user within the electronic services network;
registering a second user within the electronic services network;
receiving a request from the first user to transfer at least a portion of the electronic money to the second user;
and electronically transferring the at least a portion of the electronic money to a mobile device belonging to the second user in response to the request received from the first user, the electronic transfer occurring within the electronic communications network.

In an implementation in accordance with the invention, the method consists in sending values which are divisible in amounts corresponding to one or more existing banknotes which are in circulation in the country where the money is sent.

In an implementation in accordance with the invention, the method comprises the steps of:

receiving a request from the second party to convert the at least a portion of the electronic money into banknotes;
sending a message to the mobile device of the second user with a PIN;
and withdrawing the banknotes from an ATM using the PIN.

In an implementation in accordance with the invention, the first party and the second party are the same party.

In an implementation in accordance with the invention, the method comprises the steps of:

validating the request received from the first user;
issuing a voucher to the first user, the voucher containing a PIN;
sending a message from the first user to the mobile device of the second user, the message containing the PIN;
and the second user withdrawing the banknotes from an ATM using the PIN.

In an implementation in accordance with the invention, the first party and the second party are the same party.

In an implementation in accordance with the invention, two or more Central Banks are in electronic data communication with one another and the electronic communications network so as to track the step of electronically transferring the at least a portion of the electronic money for the purpose of controlling money flow.

In an implementation in accordance with the invention, one or more watchdog entities are in electronic data communication with one another and the electronic communications network so as to track the step of electronically transferring the at least a portion of the electronic money for the purpose of preventing abuses.

### BRIEF DESCRIPTION OF THE DRAWINGS

Many aspects of the present invention can be better understood with reference to the accompanying drawings, which are part of the specification and represent exemplary embodiments of the present invention. The components in the drawings are not necessarily to scale, emphasis instead being placed upon illustrating the principles of the present invention.

FIG. 1A is a schematic diagram illustrating an exemplary services network according to a non-limiting embodiment of the present invention;

FIG. 1B is a schematic diagram illustrating the open loop manner in which information flows in the services network of FIG. 1A;

FIG. 2 is a schematic diagram illustrating an exemplary architecture of a central services server according to a non-limiting embodiment of the present invention;

FIG. 3 is a schematic diagram illustrating an exemplary physical and logical arrangement of various external system adapters of the central services server of FIG. 2;

FIG. 4 is a schematic diagram illustrating an exemplary physical and logical arrangement of a customer care management system within the services network of FIG. 1A;

FIG. 5 is a schematic diagram illustrating an exemplary arrangement of the various software modules within the architecture of FIG. 2;

FIG. 6 is a schematic diagram illustrating the levels of data flow within the services network of FIG. 1A;

FIG. 7 is a schematic diagram illustrating the flow of data between the various entities/devices within the services network of FIG. 1A;

FIG. 8 is a flow chart illustrating exemplary steps taken to effectuate electronic money transfers according to a non-limiting embodiment of the present invention; and

FIG. 9 is a flow chart illustrating an exemplary implementation of the method in accordance with the present invention.

### DETAILED DESCRIPTION OF THE PREFERRED EMBODIMENTS

Elements that are structurally and functionally identical, and that are present in more than one distinct figure or illustration, are given the same numeric or alphanumeric reference in each of them.

The present invention includes a system and method for providing fungible electronic money that can be exchanged between parties, nationally and internationally, as freely as banknotes. The present invention also includes a system and method for providing the appropriate oversight at the Central Bank level for controlling and regulating the flow of that electronic money. The system and method of the present invention, which also involves the issuance of digital currency by Central Banks to progressively replace banknotes, are implemented via the GLOBAL STANDARD FOR MONEY TECHNOLOGY (GSMT) brand electronic money system, which is named after inventor Roberto Giori. Accordingly, the system and method of the present invention are hereinafter referred to collectively as the “GSMT”. GSMT is a system to be used in a digital transmission environment, which aims to progressively replace the use of classic banknotes (paper currency) with use of a worldwide continually traceable, unique and non-reproducible digital/electronic bank note. GSMT is a system which aims to become a standard worldwide in digital/mobile money. GSMT is a new government resource which will not only include the generation of codes designed to progressively substitute banknotes (or paper money), but will also incorporate the highest levels of secure encryption and means of transmission, data compression, leveraging the latest in mobile technology, and which will lead to the establishment of globally issued guidelines and protocols correlated to the issuance of digital money.

In one application of the present invention, the shortcomings of a “closed loop” system are overcome. For example, GSMT provides an “open loop” system and method for transferring or transmitting money that uses principles and security measures similar to those currently employed in banknote printing to transfer money electronically. The GSMT provides an open loop system by integrating existing money transfer systems (e.g., MTO systems, mobile money systems, etc.) with the institutional systems used within the financial framework of commercial banks and Central Banks (e.g., the Federal Reserve Wire Network (FedWire) system, the Clearing House Interbank Payments System (CHIPS), the Clearing House Automated Payment System (CHAPS), the Clearing House Automated Transfer System (CHATS), the Society for Worldwide Interbank Financial Telecommunication (SWIFT) system, etc.). And the GSMT provides security measures similar to those currently employed in banknote printing by having Central Banks in the various countries where the GSMT is provided guarantee, or back, the money transferred within the GSMT.

In more detail, just as the banknotes (i.e., paper money and coinage) that are utilized in each country are under 100% control of the Central Banks in those countries, the electronic money (i.e., money in the form of electronic data) utilized in the GSMT will be under 100% control of Central Banks. Accordingly, just as Central Banks in each country are responsible for the production and distribution of banknotes in those countries, Central Banks will be responsible for the production and distribution of electronic money in the GSMT. And just as Central Banks delegate certain financial activities to commercial banks and other institutions when printing and distributing banknotes, Central Banks will be able to delegate certain financial activities to commercial banks and other institutions within the GSMT (e.g., post offices, MTOs, cellular service providers, automated teller machine (ATM) operators, etc.), such as issuing electronic money into the GSMT. That electronic money will be encrypted/encoded with serial numbers and electronic watermarks by the issuing parties as required, to prevent counterfeiting and laundering.

As an example, specific institutions operating like the COFACE or another ad hoc institution, could guarantee the electronic money utilized within the GSMT (hereinafter “Giori Money”), that Giori Money will be represent a liability of those Central Banks. Accordingly, that Giori Money will be recognized as actual, fungible currency instead of the pseudo-currency, or mobile scrip, currently issued by cellular service providers as part of conventional mobile money transfers. As a result, users of the GSMT will effectively be able to exchange Giori Money with any person and/or entity that has a suitable electronic device (e.g., mobile telephone, personal computing device, etc.), nationally and internationally, which further opens the loop of that open loop system. Finally, there will be no financial risk for the Central Banks. As will become more evident from the disclosure below, such an open loop system not only provides advantages to parties sending and receiving money (e.g., immigrants abroad, the unbanked and unbankable, etc.), it also provides advantages to the parties facilitating those transfers (e.g., MTOs, cellular service providers, ATM operators, etc.). The electronic/digital money or Giori-Money, in accordance with the invention will then be guaranteed like every existing and printed banknote. The amount of money which is put by a Central Bank at the disposal of another Central Bank will be guaranteed in the same way as a bank cheque.

Additionally, the GSMT system which entails a new electronic coding method from the birth of “digital money” or Giori Money contains among many elements, the essential codes for government organizations/Central Banks to control the flow of money worldwide. The architecture of this system will greatly facilitate the management of enormous information flows to these institutions as well as the establishment of statistics regarding these financial transactions and flows.

As with the traditional banknote that flows in an “open loop”, the advantage of Giori Money is that it, too, operates on the same principle. Giori Money is as internationally recognized as banknotes are and flows between parties as banknotes currently do—in an “open system”. Giori Money, however, has the added benefit of leveraging the latest advancements in technology to be an effective, traceable financial instrument that can be managed as surplus banknotes by Central Banks under the umbrella of one, unique global standard.

In addition, the GSMT overcomes the tracking problems of conventional money transfer systems by integrating watchdog functionality into the open loop system. That watchdog facilitates Central Banks' regulation and control of money by actively monitoring the origin, destination, amount, and type of money being transferred using electronic money transfer codes (e.g., Bank Identifier Codes (BICs), International Bank Account Numbers (IBANs), currency codes, Money Transfer Control Numbers (MTCNs), etc.). That watchdog functionality also facilitates anti-money laundering and terrorism prevention efforts by actively identifying suspect transfers based on the origin, destination, amount, and types of money being transferred using government watch lists and international anti-money laundering (AML) and combating-the financing-of-terrorism (CFT) standards developed by various national and international agencies (e.g., Treasury Departments, Central Banks, the Financial Action Task Force (FATF), the Office of Foreign Asset Control (OFAC), the National Anti-Money Laundering Committee (NAMLC), the Federal Financial Institutions Examination Council (FFIEC), the Financial Transactions and Reports Analysis Centre (FINTRAC), etc.). As will become more evident from the disclosure below, such watchdog functionality not only helps regulate the flow of money and prevent abuses of the open loop money transfer system of the GSMT, it also facilitates policy analysis and information-sharing among Central Banks and within the international financial and supervisory community (e.g., the Bank for International Settlements (BIS), the International Monetary Fund (IMF), etc.).

Because the GSMT utilizes proven money transfer systems and proven institutional banking systems to effectuate Giori Money transfers, those transfers are both efficient and reliable. Because those systems are integrated into a single, open loop system, many of the steps previously required to effectuate such transfers are either automated or eliminated, thereby eliminating much of the overhead previously associated with such transfers, which makes money transfers more affordable. Integrating all of those systems into a single, open loop system also makes money transfers more accessible. And by providing an efficient, reliable, affordable, and accessible money transfer system, more people will be encouraged to use and become a part of the system, thereby increasing its effectiveness. Moreover, by encouraging more people to use the system, money is removed from unofficial channels, thereby enforcing the strength and relevance of financial institutions. It is the first system designed to drastically eliminate the circulation of money in unofficial channels, and it is particularly suited for international application because of its efficiency, reliability, affordability, and accessibility.

In describing the preferred embodiments of the GSMT illustrated in the drawings, specific terminology will be resorted to for the sake of clarity. However, the GSMT is not intended to be limited to the specific terms so selected, and it is to be understood that each specific term includes all technical equivalents that operate in a similar manner to accomplish a similar purpose. For example, the term “mobile money” is generally used to refer to money transfers made to and/or from mobile devices (e.g., mobile telephones, personal digital assistants (PDAs), smart phones, etc.), but it may also be used to refer to money transfers to and/or from other electronic devices (e.g., personal computers, laptops, electronic banking systems, ATMs, etc.).

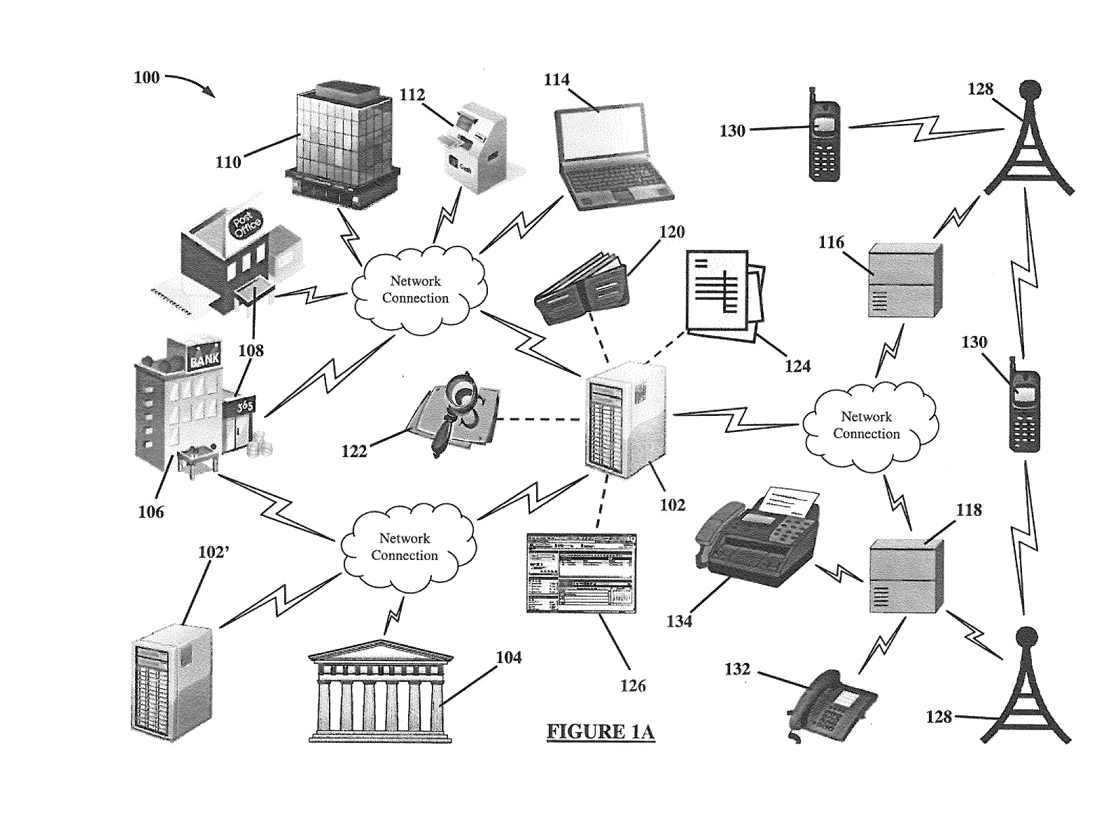

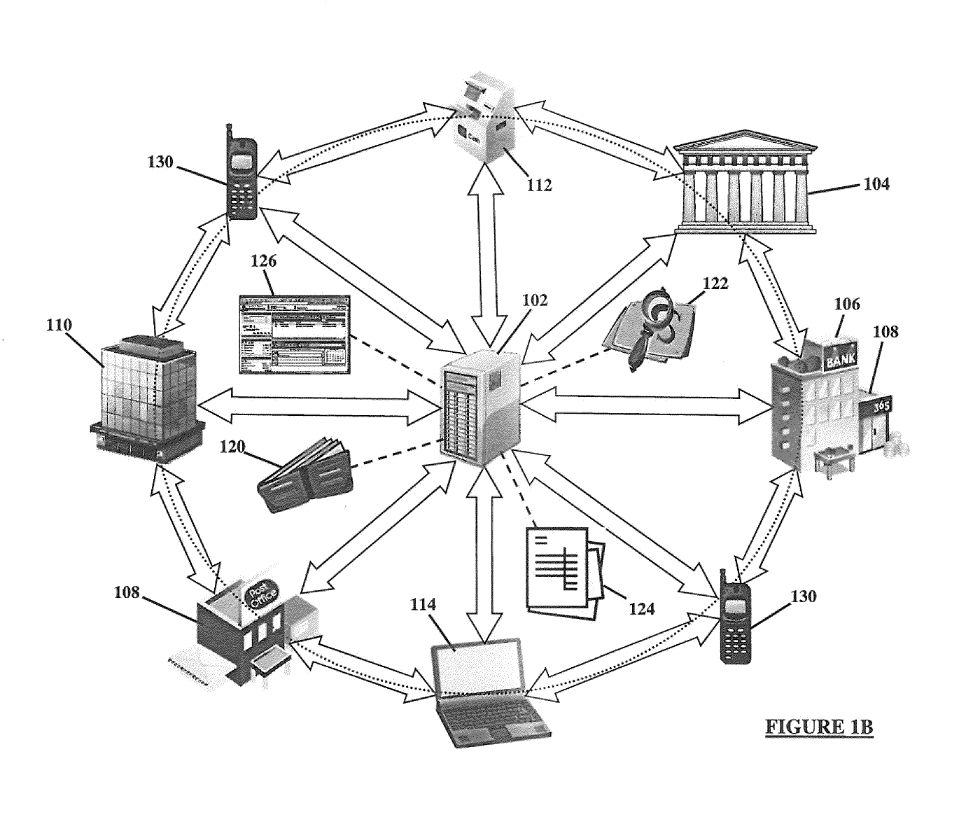

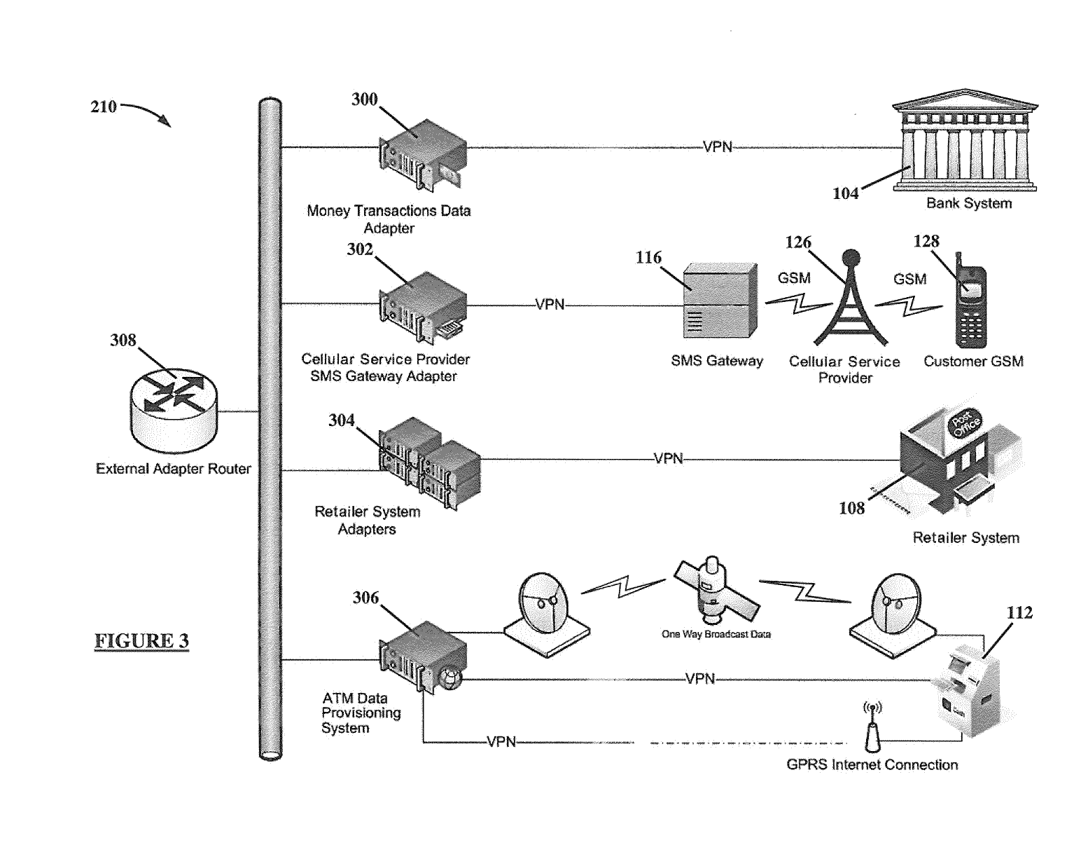

Turning to the drawings, FIG. 1A is a schematic diagram illustrating a services network 100 according to an exemplary embodiment of the GSMT. As FIG. 1A illustrates, a central services server 102 is provided at the center of the services network 100 that is in electronic data communication with two or more Central Banks 104 and one or more commercial banks 106. The central services server 102 is also in electronic data communication with one or more retail establishments 108, one or more payors 110, one or more ATMs 112, one or more personal computing devices 114, one or more mobile network hubs 116, and one or more private branch exchange (PBX) hubs 118. And the central services server 102 is in electronic data communication with cellular service providers 128, mobile devices 130, switched telephones 132, fax machines 134, etc. via the one or more mobile network hubs 116 and one or more PBX hubs 118. That electronic data communication can be achieved via any suitable network connection, or combination of network connections, between the central services server 102 and each of those other entities/devices 104-118 and 128-134 (e.g., Virtual Private Network (VPN), Dedicated Line, Satellite Network, Public Switched Telephone Network (PSTN), Global System for Mobile Communications (GSM) Public Land Mobile Network (PLMN), etc.). See, e.g., FIG. 3.

The central services server 102 may also be in electronic data communication with one or more other central services servers 102′ at different geographic areas (e.g., in different mobile networks, different cities, different states, different countries, etc.) via one or more secured network connections. Each of those other central services servers 102′ is in electronic data communication with corresponding entities/devices 104-118 and 128-134 in those different geographic areas. And all of those other central services servers 102′ are also in electronic data communication with each other, such as through a single central services server 102 acting as the hub of the services network 100. That interconnectivity allows the GSMT to facilitate the transfer of money across an expansive network and, moreover, to track those transfers from a central location as they occur.

The central services servers 102 and 102′ are operated and maintained by the providers of the money transfer services of the present invention (hereinafter “MTS Providers”). Those providers may be different entities in different geographic areas or a single, common entity. But each provider should be approved by the Central Bank 104 responsible for controlling and regulating the distribution of money in that geographic area. To effectuate and track the Giori Money transfers of the present invention, each central services server 102 and 102′ preferably includes virtual wallet, or E-wallet, functionality 120 configured to automatically keep track of how much Giori Money a specific party possess, watchdog functionality 122 configured to automatically track Giori Money transfers between parties and identify suspect transactions, and virtual banking functionality 124 configured to provide electronic banking services. Each central services server 102 and 102′ also includes customer relationship management (CRM) functionality 126 configured to manage the MTS Providers' interactions with its current and potential Customers. Each of those types of functionality is preferably provided via software applications that are stored on a computer-readable medium (e.g., hard disk drive, optical disk, flash memory, etc.) as instructions that are executed by a processor on the central services servers 102 and 102′.

FIG. 1B is a schematic diagram illustrating the open loop manner in which information flows in the services network 100 of FIG. 1A. As FIG. 1B illustrates, information flows between Central Banks 104, commercial banks 106, retail establishments 108, payors 110, ATMs 112, personal computing devices 114, and mobile devices 130 in an open loop via the electronic data communication facilitated by the services network 100, thereby allowing various money transfer systems (e.g., MTO systems, mobile money systems, banking systems, etc.) to communicate freely with one another so that customers are no longer subject to the limitations of any single money transfer system (e.g., limited access, limited geographic range, limited usefulness of scrip, etc.). At the center of that open loop is the central services server 102, which not only helps facilitate some of that data communication, but also monitors and tracks the flow of money within that open loop to support the E-wallet functionality 120, watchdog functionality 122, virtual banking functionality 124, and CRM functionality 126 of the GSMT.

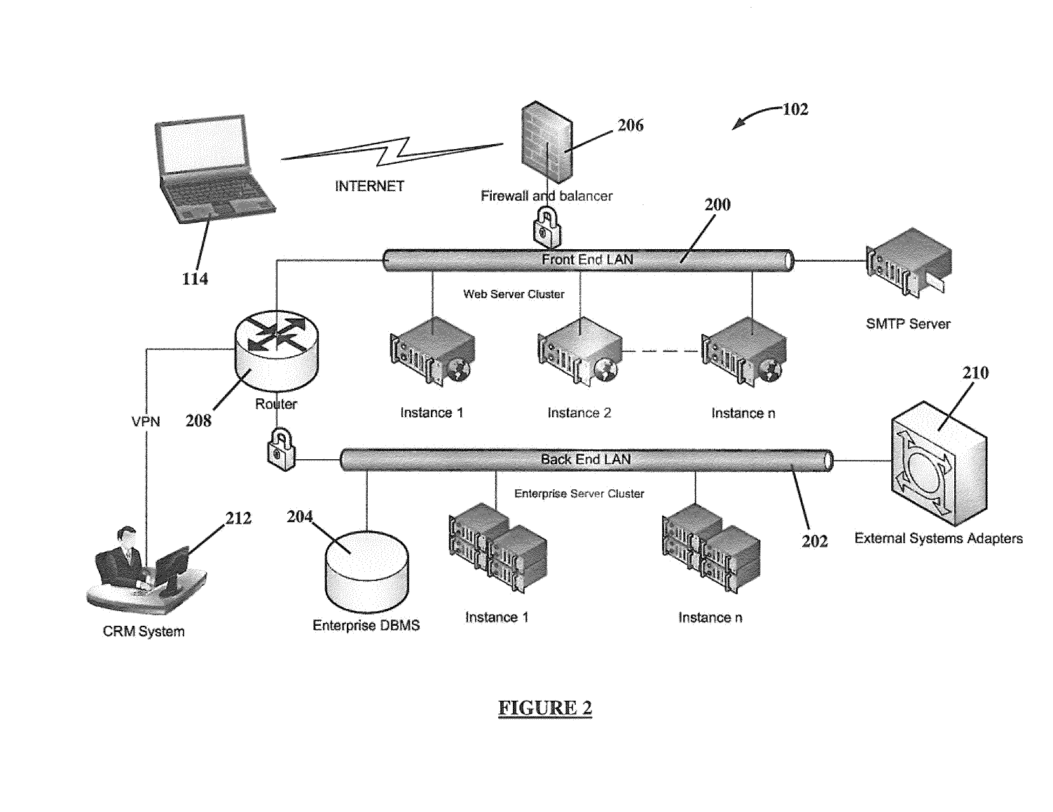

As illustrated in FIG. 2, each central services server 102 includes “front-end” applications 200 and “back end” applications 202 that support the E-wallet functionality 120, watchdog functionality 122, virtual banking functionality 124, and CRM functionality 126 of the GSMT. The front-end applications 200 are the applications that Customers and Customer Care Operators interact with directly, such as web applications. Customers and Customer Care Operators interact with those applications via user interfaces, such as personal computing devices 114 and mobile devices 130. Those applications provide the main gateway by which Customers and Customer Care Operators can access the E-wallet functionality 120, watchdog functionality 122, virtual banking functionality 124, and CRM functionality 126 of the GSMT. And the back-end applications 202 serve to support the front-end applications by providing all of the procedures, data accesses, and interactions with external systems and networks that are required to control the functionality of the front-end applications 200.

The central services server 102 also includes an enterprise database management system (DBMS). The enterprise DBMS collects data and organizes it in a database 204 so that data can more easily be accessed, managed, and updated by the back-end applications 202. In the present invention, the database 204 contains aggregations of data records, such as sales transactions of money transferred, customer profiles, and other data that is necessary to track and regulate Giori Money transfers in accordance with the requirements of the Central Banks 104. Accordingly, the central services server 102 employs a three-tiered architecture, with the frontend applications 200 operating as the presentation tier, the back-end applications 202 operating as the business logic tier, and the database 204 operating as the data tier. That configuration not only improves the scalability of each central services server 102, but also of the entire services network 100.

The central services server 102 also includes a firewall 206, a router 208, and various external systems adapters 210. The firewall 206 is used to prevent unauthorized Internet users from accessing the core structure of the central services server 102 when it is connected to the services network 100 via an Internet connection. The router 208 decides which way to send data, such as information packets, based on its current understanding of the state of the services network 100. It connects the back-end applications and front-end applications to external systems and networks at the banks 104/106, retail establishments 108, payors 110, ATMs 112, personal computing devices 114, mobile network hubs 116, and PBX hubs 118 with which the central services server 102 is connected. And the external systems adapters 210 include various modules that are dedicated to interact with those external systems and networks.

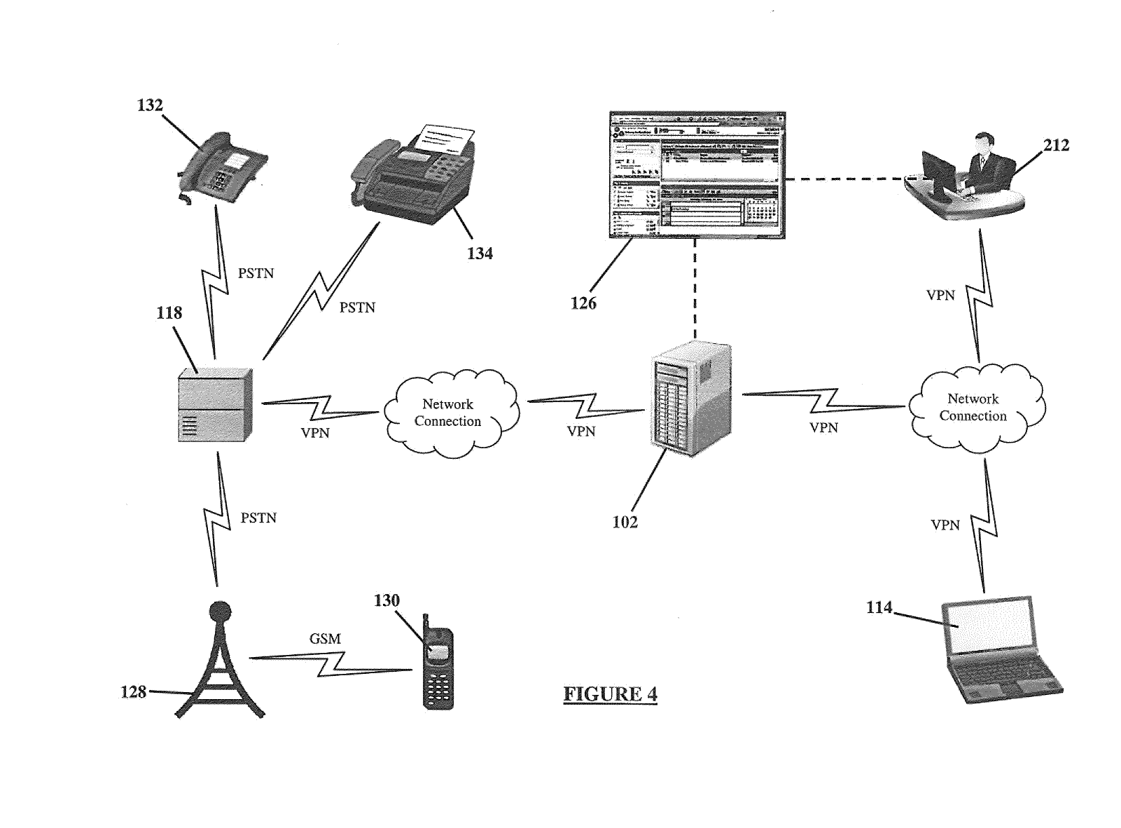

As FIG. 2 also illustrates, the central services server 102 is in electronic data communication with one or more customer relations management (CRM) systems 212. Each CRM system 212 is built on substantially the same architecture as the central services server 102 and, therefore, can communicate with the central services server 102 without the need for any external systems adapters 210. Moreover, the work flows of the central services server 102 can be integrated into the work flows of each CRM system 212, and vice versa, without the need for complex interfaces. And it is through those communications and workflows that the central services server 102 and the CRM system 212 implement the CRM functionality 126 of the present invention. See, e.g., FIG. 4.

FIG. 3 illustrates the physical and logical arrangement of various external system adapters that place the central services server 102 in electronic data communication with the various external systems and networks at the banks 104/106 (e.g., FedWire, CHIPS, CHAPS, CHATS, SWIFT, etc.), retail establishments 108 (e.g., MTO systems, mobile money systems, PAYPAL brand payment systems, PAYPOINT brand payment systems, etc.), payors 110 (e.g., KRONOS brand payroll systems, SAGE brand payroll systems, AXONWARE brand payroll systems, FIRST DATA brand payroll systems, etc.), ATMs 112 (e.g., Central Bank ATM networks, commercial bank ATM networks, ATM provider ATM networks, etc.), personal computing devices 114, mobile network hubs 116, and PBX hubs 118 with which the central services server 102 is connected. For example, a Money Transactions Data Adapter 300, a Cellular Service Provider SMS Gateway Adapter 302, a retailer System Adapter 304, and an ATM Data Provisioning System Adapter 306 are provided as part of the external systems adapters 212. A separate External Adapter Router 308 may also be provided as part of the external systems adapters 210. In that configuration, the external adapter router 308 connects the back-end applications 202 to the Money Transactions Data Adapter 300, the Cellular Service Provider SMS Gateway Adapter 302, the Retailer System Adapter 304, and the ATM data Provisioning System Adapter 306. And the Money Transactions Data Adapter 300 is connected to electronic banking systems at banks 104/106, the Cellular Service Provider SMS Gateway Adapter 302 is connected to cellular service provider gateways at mobile network hubs 116, the Retailer System Adapter 304 is connected to electronic retailer systems at retail establishments 108 and payors 110, and the ATM Data Provisioning System Adapter 306 is connected to ATMs 112 at various geographic areas. In that way, the central services server 102 can send and receive data to and from each of the entities/devices 104-118 and 128-134 in the services network 100.

FIG. 4 illustrates the physical and logical arrangement of a customer care management system 212 within the services network 100. As discussed above, the central services server 102 and the customer care management system 212 share integrated CRM functionality 126. That CRM functionality 126 organizes, automates, and synchronizes various business processes to help Customers resolve any issues that may arise when effectuating a Giori Money transfer with the present invention. For example, a Customer can use a mobile device 130, a switched phone 132, or a fax machine 134 to connect to a PBX hub 118 by calling a local or toll-free telephone number provided by the local telephone company. The PBX hub 118 routes that call to the central services server 102, preferably via low cost Internet Protocol (IP) methodologies, such as Voice Over IP (VoIP), to reduce costs for Customers. And the central services server 102 connects the call to a CRM system 212, where a Customer Care Operator will address the issues that form the basis for the Customer's call using web-based applications provided by the CRM functionality 126. Such Customer Care Operators may provide support for the overall service network 100 or for a specific entity 104-110 and 128 within the services network 100 so as to provide a viable chain of communication between the users and suppliers of financial services within the services network 100.

Because switched phones 132 and fax machines 134 are typically provided in the same communications network as a PBX hub 118, such as a PSTN, they can make direct connections with the PBX hub 118 from within that network. Mobile devices 130, however, are typically in a different communications network than a PBX hub 118, such as a GSM PLMN network (hereinafter “GSM”). Accordingly, mobile devices 130 must connect to the PBX hub 118 via a Mobile Telephone Switching Office (MTSO) at a cellular service provider 128, which utilizes switching equipment or a Mobile Switching Center (MSC) to re-code the GSM signal format (e.g., Time Division Multiple Access (TDMA), Code Division Multiples Access (CDMA), Frequency Division Multiple Access (FDMA), etc.) into the PSTN signal format (e.g., Dual-Tone Multi-Frequency (DTMF), Pulse-Code Modulation (PCM), Digital Signal 0 (DS0), etc.) so that the data being transmitted from the mobile device 130 in the GSM network can be understood by the PBX hub 118 within the PSTN. The cellular network provided by the cellular service provider 128 can utilize any suitable wireless technology to exchange data with the mobile device 130 (e.g., fourth generation cellular (4G), Worldwide Interoperability for Microwave Access (WiMAX), Long Term Evolution (LTE), etc.). In that way, the PBX hub 118 can route calls to the central services server 102 from different customers in different communications networks. Moreover, such calls can be routed to the central services server 102 from different PBX hubs 118 in different countries so as to provide a central access point for connecting to a CRM system 212, which can be located as required to further reduce costs for Customers (e.g., it can be outsourced to a geographic area with lower operating costs).

At the CRM system 212, the Customer Care Operator may be a live person that the Customer can engage in a conversation, or it may be Interactive Voice Response (IVR) technology that the Customer must interact with via voice commands and DTMF keypad inputs. The latter alternative can be used to even further reduce costs for Customers. And as yet another alternative, Customers can access the web-based applications of the CRM functionality 126 by connecting to the central services server 102 and/or the CRM system 212 via a personal computing device 114 or mobile device 130, whereby the Customer can navigate through web pages to identify resolutions to issues. The customer may also engage in a text-based conversation with a Customer Care Operator via Internet messaging tools (e.g., instant messengers, Internet Relay Chat, etc.) that are provided as part of the CRM functionality 126.

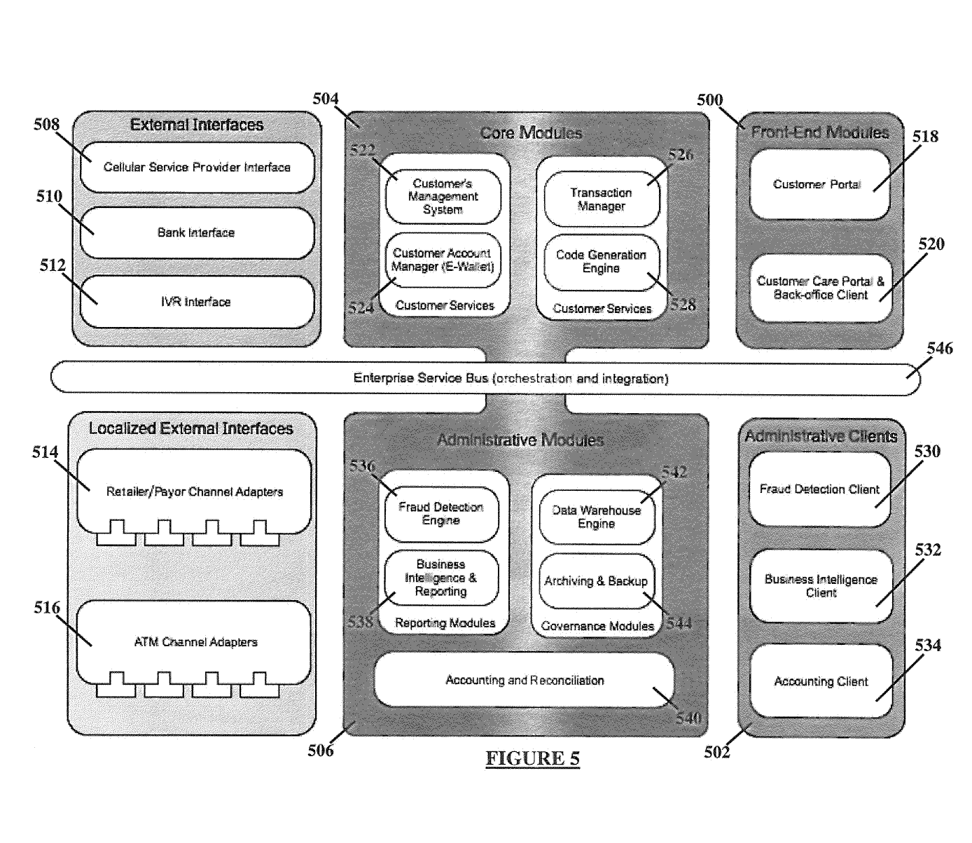

FIG. 5 illustrates the logical arrangement of the various software modules of the present invention according to the tiered architecture discussed above. The presentation tier includes Front-End Modules 500 and Administrative Clients 502. And the business logic tier includes Core Modules 504 and Administrative Modules 506. The logical arrangement of various external interfaces 508-516 for exchanging data with the entities/devices 104-118 and 128-134 in the services network 100 is also illustrated.

In the presentation tier, the Front-End Modules 500 provide a Customer Portal 518 through which a Customer can access a graphical user interface, such as a web page, via a personal computing device 114 or mobile device 130. Using that user interface, a Customer can become a member of the services network 100, control transactions within the services network 100, and utilize the E-wallet functionality 120, virtual banking functionality 124, and CRM functionality 126 of the present invention. The Front-End Modules 500 also include a Customer Care Portal & Back-Office Client 520 through which a Customer Care Operator can access a graphical user interface, such as a web page, via a CRM system 212. Using a CRM system 212, which may be a personal computing device 114 with specific accesses to certain Customer data otherwise not available to the Customer, a Customer Care Operator can utilize the CRM functionality 126 of the present invention to view and manage that Customer data, to view and manage various trouble ticketing items, and to perform various marketing tasks. For example, that CRM functionality 126 can be used to find, attract, and win new Customers, to nurture and retain existing Customers, and to entice former Customers to rejoin the service network 100.

In the business logic tier, the activities that can be performed with the two portals of the Front-End Modules 500 are supported by the Core Modules 504. For example, a Customer's Management System 522 provides functionality for Customers to set personal preferences for Giori Money transfers, including passwords, maximum transfer limits, default bank and/or credit card accounts, scheduled transfers, etc. A Customer Account Manager 524 provides functionality for a Customer to manage a virtual, or paperless, account so the Customer can keep track of how much fungible currency he or she possess within the services network 100 and effectuate Giori Money transfers within the services network 100. A Transaction Manager 526 provides functionality for interacting with the various entities/devices 104-118 and 128-134 within the services network 100 to effectuate those Giori Money transfers. And a Code Generation Engine 528 module generates codes that are unique to each of those transactions so those transactions can be properly authenticated.

Together, the functionalities of the Customer's Management System 522, Customer Account Manager 524, and Transaction Manager 526 (i.e., the E-wallet functionality 120, virtual banking functionality 124, and CRM functionality 126) operate like a virtual, or branchless, bank. In other words, those functionalities operate like an electronic banking system (e.g., the ING DIRECT brand electronic banking system, the WIZZIT brand electronic banking system, the EASYPAISA brand electronic banking system, etc.) in which a user can set up and maintain a virtual, or paperless, savings accounts and checking accounts in which that user keeps its Giori Money and to/from which Giori Money is transferred. For example, the customer can use the Customer's Management System 522 to transfer money into one of those virtual accounts from an account at a branched, or brick-and-mortar, commercial bank. The customer can obtain an accounting of those virtual accounts with the Customer Account Manager 524. And the customer can write electronic checks and make withdrawals, direct debits, and Giori Money transfers from those virtual accounts with the Transaction Manager 526. To make such virtual accounts more accessible to low income individuals, they preferably will not have minimum balance or direct deposit requirements or monthly maintenance fees. And the virtual savings accounts will preferably pay tiered interest rates according to account balance, wherein virtual saving accounts with smaller balances will earn interest based on lower rates than virtual savings accounts with larger balances.

The virtual bank supported by the the functionalities of the Customer's Management System 522, Customer Account Manager 524, and Transaction Manager 526 will be provided as the PEOPLE′S MOBILE SAVINGS BANK (PMSB) brand virtual bank. The PMSB will be controlled by a holding company made up of various international banks (e.g., the Union Bank of Switzerland (UBS), the Hongkong and Shangai Banking Corporation (HSBC), the Société Génerale, the Bank of China, etc.) that are responsible for supporting the functionality of the PMSB in the geographic area (e.g., community, city, region, country, etc.) in which they are located. Central Banks 104 may also take an interest in the holding company that controls the PMSB. Together, those banks will not only ensure that the PMSB operates in accordance with the laws and regulations in each of their corresponding geographic areas, they will also provide other banking services (e.g., investment products, asset management, wealth management, etc.) to customers in those geographic areas.

The banks that make up the holding company will support the functionality of the PMSB in the geographic area in which they are located by lending their know-how on local laws and regulations and their know-how on money transfers to help define the activities performed in the business logic tier. As discussed above, that know-how is incorporated into the GSMT via the integration of those banks' institutional banking systems into the services network 100 of the present invention. And the PMSB provides a central access point for accessing the banking services of all of those banks via the Front-End Modules 500 in the the presentation tier.

Also in the presentation tier, the Administrative Clients 502 provide functionality for the MTS Provider to perform various administrative tasks required to effectuate Giori Money transfers. For example, a Fraud Detection Client 530, Business Intelligence Client 532, and Accounting Client 534 are provided for use by the MTS Provider in the form of a graphical user interface, such as a web page, that allows the MTS provider to identify potential frauds and to view and manage various information regarding the Giori Money transfers occurring within the services network 100 (e.g., intelligence, accountings, reports, etc.).

In the business logic tier, the activities that can be performed with the Administrative Clients 502 are supported by the Administrative Modules 506. For example, a Fraud Detection Engine 536 provides functionality for automatically monitoring each electronic money transfer that occurs within the services network 100 and automatically identifying any potential abuses of the services network, such as fraudulent transactions, money laundering, and funding terrorism.

Money laundering and terrorism funding are identified based on the origin, destination, amount, and type of money being transferred by using government watch lists and AML/CFT standards to identify suspect transactions. And fraudulent transfers are indentified by building a profile of each customer and looking for activity that is outside of the expected range of activity for that customer. Similar functionality is currently used by commercial banks, cellular service providers with mobile money systems, and other electronic payments systems (e.g., the PAYPAL brand payment system), but those conventional systems are not integrated across a single, open loop system, as in the services network 100 of the present invention. The integration of different money transfer systems in the present invention allows the sharing of data so abuses can be identified more quickly and more accurately, such as if a person were dividing its transactions between different money transfer systems to avoid detection. And because the Giori Money issued into the services network 100 of the GSMT is encrypted/encoded with serial numbers and electronic watermarks, the Fraud Detection Engine 536 also identifies potential abuses by authenticating transactions using those serial numbers and electronic watermarks in conjunction with the unique transaction codes generated by the Code Generation Engine 528.

The watch lists and AML/CFT standards used to detect those abuses are obtained from various national and international agencies (e.g., Treasury Departments, Central Banks 104, FATF, OFAC, NAMLC, FFIEC, FINTRAC, etc.) so as to ensure any Giori Money transfer performed within the services network 100 of the GSMT, nationally or internationally, is being monitored in accordance with the requirements of both the region from which the money is transferred and the region in which the money is received. That information can be manually input into the central services server 102 by the MTS Provider using the Fraud Detection Client 530 or, when available electronically, automatically downloaded from the various agencies responsible for maintaining that information. After that information is input or downloaded, it is consumed as rules that are used to automatically identify actual and potential abuses of the services network 100 based on certain triggering events (e.g., recognition of a name on a watch list, recognition of a pattern of suspect transfer amounts, recognition of an improperly authenticated transaction, etc.).

A Business Intelligence & Reporting module 538, an Accounting and Reconciliation module 540, a Data Warehouse Engine 542, and an Archiving & Backup module 544 are also provided in the business logic tier. The Business Intelligence & Reporting module 538 provides functionality for automatically identifying, digging-out, and analyzing various business data, such as the number and amount of Giori Money transfers by geographic area, retailer 108, payor 110, etc., as well as any sales revenues, costs, and incomes associated therewith. The Accounting and Reconcilliation module 540 provides functionality for automatically comparing multiple sets of data to ensure that the money being sent via each Giori Money transfer matches the amount of money received via each respective Giori Money transfer, which can include making sure the proper exchange rate was applied when a Giori Money transfer is conducted between geographic areas with currencies of different value. The Data Warehouse Engine 542 provides functionality for automatically collecting transactional data from the various entities/devices 104-118 and 128-134 within the services network 100 into a central data location (e.g., database 204) and reporting those data to the MTS Provider and Central Banks 104, generally in an aggregated manner. And the Archiving & Backup module 544 provides functionality for automatically organizing and storing the transactional data collected by the central services server 102 in a duplacte manner. That functionality helps support the monitoring functionality of the Fraud Detection Engine 536 and virtual banking functionality 124 of the Core Modules 504.

The processes performed by the Core Modules 504 are integrated with the processes performed by the Administrative Modules 506 via an Enterprise Service Bus 546. The transactions that are effectuated by those processes are supported by various external interfaces that provide data connections (e.g., VPN over IP, Dedicated Line, etc.) to the various entities/devices 104-118 and 128-134 within the services network 100. For example, a Cellular Service Provider Interface 508 allows transaction data to be exchanged with mobile devices 130 via a cellular service provider 128. A Bank Interface 510 allows transaction data to be exchanged with electronic banking systems at banks 104/106. And an IVR Interface 512 allows voice commands and DTMF keypad inputs from a mobile device 130 or switched telephone 132 to be received and understood by a CRM system 212 with IVR functionality.

Those external interfaces 508-512 are particularly suited for exchanging data with entities/devices 104-118 and 128-134 that correspond to larger geographic areas, such as banks 104, cellular service providers 128, and CRM systems 212. For example, a Central Bank 104 is a public institution that issues all of the currency in a specific country. Similarly, a cellular service provider 128 can provide cellular service across an entire continent. Accordingly, the central services server 102 may require only a single interface with the communication system of a Central Bank 104 or cellular service provider 128 in a certain country for the purpose of effectuating and tracking Giori Money transfers in that country. However, the various retail establishments 108, payors 110, and ATMs 112 within a given country are not likely to be under the control of a central entity and, therefore, are likely to utilize disparate communication systems. As a result, different adapters will be needed to interface with each of those different communications systems.

To support connectivity with the various retail establishments 108, payors 110, and ATMs 112 within a given geographic area, the central services provider also includes “localized” external interfaces 514 and 516. For example, a Retailer/Payor Channel Adapter 514 allows transaction data to be exchanged with retailer systems and payor systems at retail establishments 108 and payors 110, respectively, in a specific geographic area. And an ATM Channel Adapter 516 allows transaction data to be exchanged with ATMs 112, or ATM clusters, in a specific geographic area. Those ATMs 112 can be provided by a third party (e.g., a commercial bank 106, an ATM operator, etc.), leased to third parties by Central Banks 104, or they can be proprietary to the MTS Provider. In the latter instance, the ATMs 112 may be built on the same architecture as the central services server 102 so the central services server 102 can communicate directly with and logically control those ATMs 112 without the need for an ATM Channel Adapter 516.

The above-described configurations provide fast integration among software modules with safe data management while enabling the MTS Provider to increase the capacity of the services network 100 as fast as Customer demand requires. Such an objective is preferably achieved using a combination of open source software technology, such as RED HAT brand open source software technology, and proprietary DBMS software, such as ORACLE brand proprietary DBMS software. For example, the JBOSS brand application server suite made by RED HAT can be used to enhance the number of servers according to transaction growth without software modifications and additional expenses. And the ORACLE brand proprietary DBMS software can manage very large databases without the need for frequent software server upgrades. High availability and disaster recovery policies are key features provided by that platform.

That functionality and infrastructure provides an efficient, reliable, affordable, and accessible system and method for transferring. More specifically, the use of highly automated data exchanges to effectuate the Giori Money transfers of the present invention over an existing infrastructure of communications networks makes those Giori Money transfers efficient and reliable. And the integration of various money transfer systems into a single, open loop system allows many of the steps otherwise required to effectuate such transfers to be either automated or eliminated, thereby eliminating much of the overhead previously associated with such transfers, which the makes Giori Money transfers of the present invention more affordable. That integration also makes the Giori Money transfers of the present invention more accessible, allowing one party to make a transfer from one money transfer system (e.g., an MTO system) to a party utilizing what would otherwise be a separate money transfer system (e.g., a mobile money system).

The improved access provided by the present invention is best illustrated by its integration of MTO systems with mobile money systems. More specifically, international experiences suggest that money transfer systems thrive in markets where there is low penetration of banking services and there is an important inflow of international remittances. And there are over one billion people in developing countries that have mobile telephones but no access to banking services. That number is expected to rise to 1.7 billion in less than two years. Using Africa as a more specific example, at least 75% of its population of 1.1 billion has no access to formal banking services. But soon, as much as 80% of its population is expected to have mobile telephones. Those numbers stand in stark contrast to the number of people with access to the internet, with Africa being considered the “least wired” continent in the world. Thus, by integrating MTO systems with mobile money systems, the present invention will provide far greater access to low-income parties—in particular, the unbankable and unbanked.

The functionality and infrastructure of the present invention also provides an effective way to track money transfers, thereby allowing the appropriate institutions to regulate such transfers and prevent potential abuses. For example, the use of mobile devices 130 to make Giori Money transfers helps better identify who is sending and receiving that Giori Money. More specifically, cellular service providers in many countries require customers to submit verifying documentation before those customers are provided cellular service. That prevents people from obtaining mobile devices 130 using false indentifying information. Moreover, that identifying information is associated with the specific customer via the Subscriber Identity Module (SIM) card provided in that customer's mobile device 130. Accordingly, a customer's SIM card can be used to facilitate the identification of the person effectuating any Giori Money transfer with a mobile device 130. Preferably, however, each person and/or entity that is permitted to effectuate Giori Money transfers within the services network 100 of the GSMT will be required to register with the MTS provider so that the sending and receiving parties of Giori Money can be more readily identified.

The functionality and infrastructure of the present invention also allows Central Banks 104 to manage and control Giori Money transferred between electronic devices (e.g., personal computing devices 114, mobile devices 130, servers hosting virtual checking or savings accounts, etc.) in the same way they manage and control banknotes physically transferred between different entities. In other words, the Central Banks 104 in each country track and control the Giori Money issued in their respective countries in the same way they track and control their the banknotes issued in their respective countries, treating that issued Giori Money as a liability and thereby making it fungible. Accordingly, the Giori Money should be recognized and receivable by anyone with an electronic device capable of receiving/storing it.

Because the Central Banks 104 will regulate and control the Giori Money that is being transferred, they form an integral part of the services network 100. And because the Giori Money will be transferred between commercial banks 106 much in the same manner that banknotes are transferred between those entities, commercial banks 106 will also form an integral part of the services network 100. In fact, the central services network 100 will preferably include, via integration, the core banking systems already used to distribute and track the money moving between commercial banks 106. And by linking those core banking systems across continents, the central services server 102 of the present invention will also be able to track the money moving between different countries.

Although they are generally not part of the core banking system of the services network 100, retail establishments 108, payors 110, and cellular service providers 128 can register with the MTS Provider to become a part of the services network 100. Those entities will be motivated to join such a services network 100 for similar reasons that they are motivated to join credit card services networks (e.g., elimination of bounced checks, shorter processing times, payments are guaranteed up front, elimination of trips to the bank, lower administrative costs, increased revenue, quicker access to funds, customer convenience, etc.). And as further motivation, the Giori Money transfers of the present invention are more accessible because they do not require a credit card or even a bank account, thereby broadening the potential customer base.

In addition, the Global System for Mobile Communications Association (GSMA) has initiated the Mobile Money for the Unbanked (MMU) program to encourage cellular service providers to offer services for mobile transfers in an effort to make money transfers more accessible to low-income parties. And according to “General Principles for International Remittance Services”, a report issued by the Bank for International Settlements in 2007, “this industry like any other, is likely to flourish best when the general legal framework in which it operates is sound, predictable, non-discriminatory and proportionate.” As just described, the functionality and infrastructure of the present invention provide just such a legal framework.

Accordingly, the present invention will help further the goals of the GSMA's MMU program.

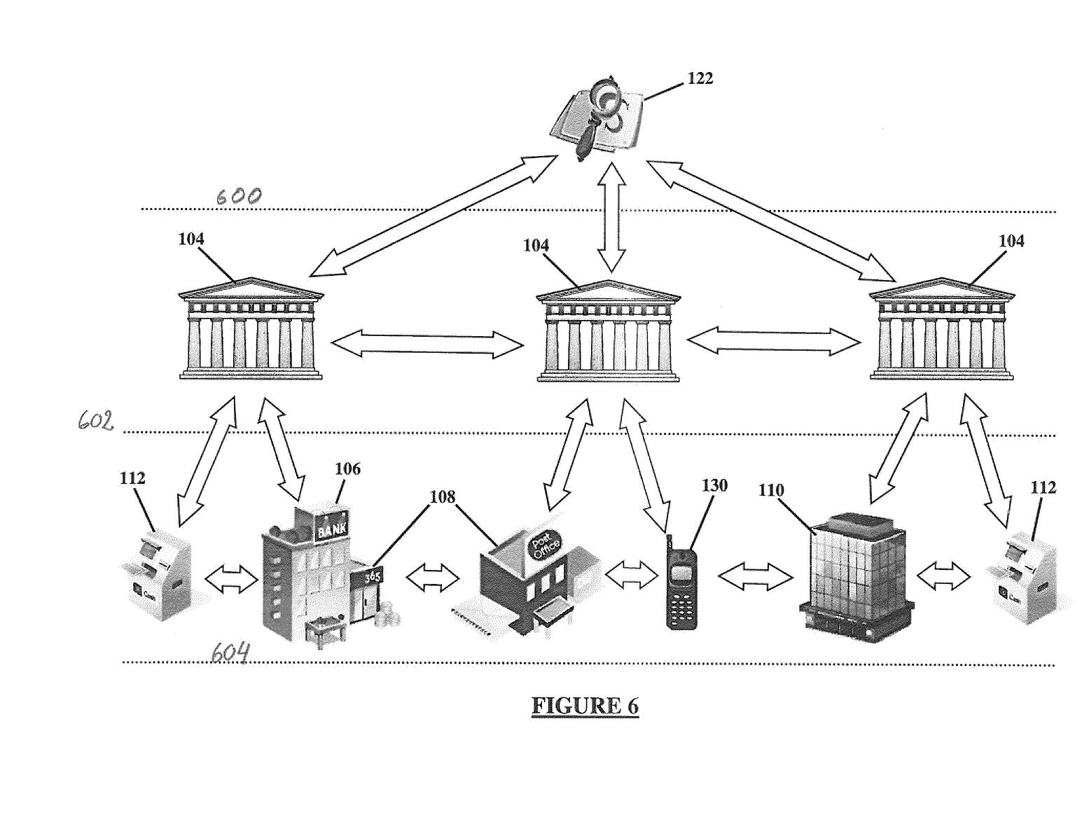

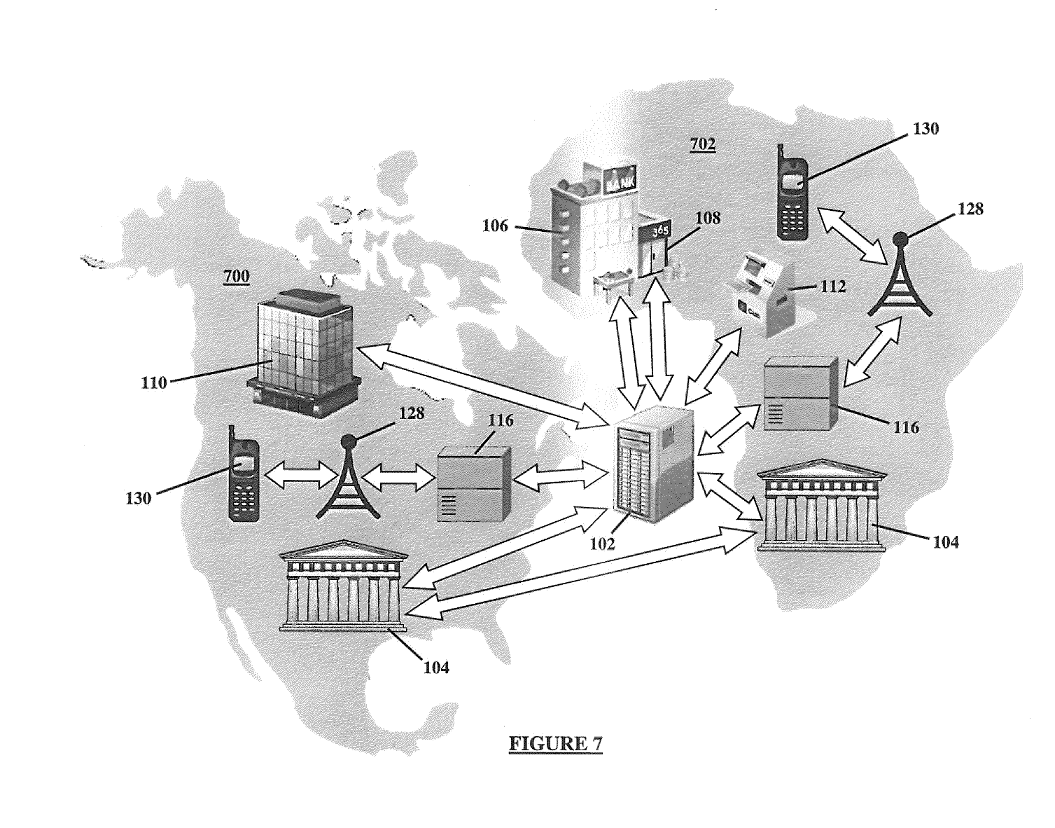

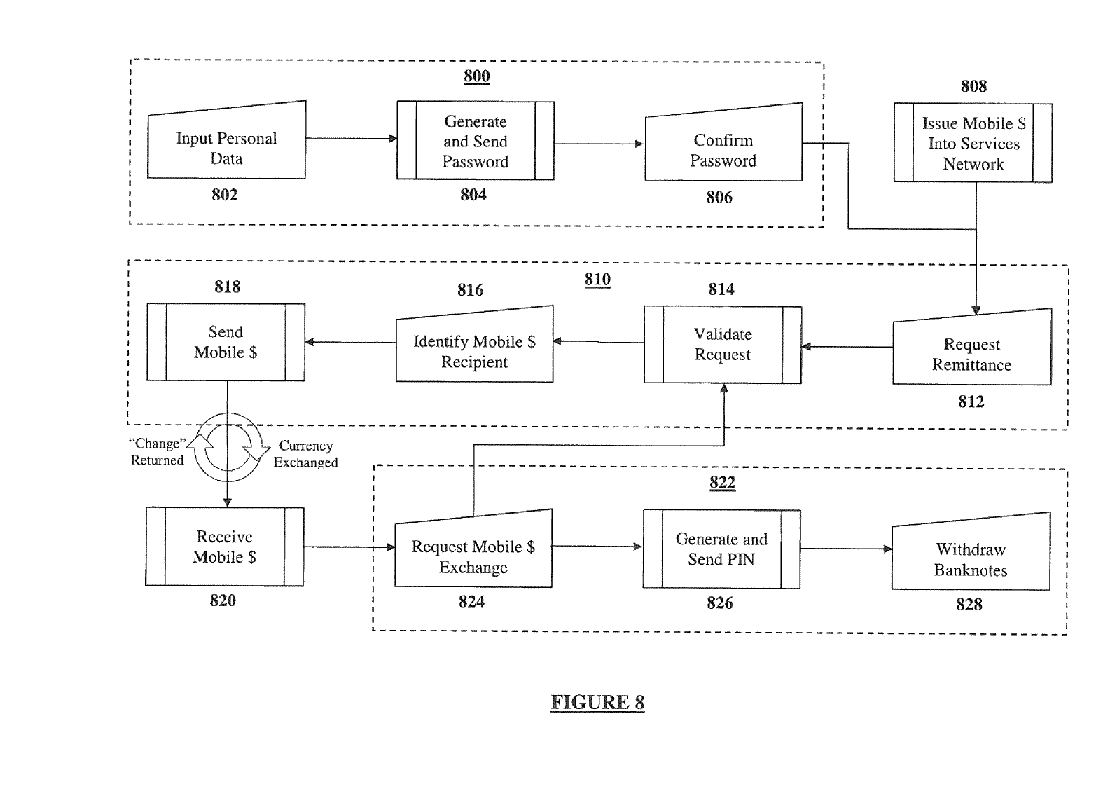

The manner in which the present invention achieves each of the benefits described above can be better understood by way of the exemplary Giori Money transfers discussed below with respect to FIGS. 6-7. FIG. 6 is a schematic diagram illustrating the levels of data flow within the services network 100 of the present invention during those exemplary Giori Money transfers. FIG. 7 is a schematic diagram illustrating the flow of data between the various entities/devices 106-118 and 128-134 within the services network 100 of the present invention during those exemplary Giori Money transfers. And FIG. 8 is a flow chart illustrating the various steps taken to effectuate those Giori Money transfers.

Turning to FIG. 6, the upper level 600 of data flow includes the watchdog functionality 122 at the central services server 102. All data regarding Giori Money transfers between the Central Banks 104 and entities/devices 106-118 and 130 within the services network 100 flows to the watchdog functionality 122. That data includes data on transfers between different Central Banks 104, between Central Banks 104 and commercial banks 106, and between the various other entities/devices 108-118 and 130 within the GSMT. International governing bodies (e.g., the Bank for International Settlements (BIS), the International Monetary Fund (IMF), etc.) can access that data so they can monitor Giori Money transfers as required to help regulate and control the flow of Giori Money within the GSMT and to develop and maintain financial policy. And the appropriate agencies (e.g., Treasury Departments, Central Banks 104, the Financial Action Task Force (FATF), the Office of Foreign Asset Control (OFAC), the National Anti-Money Laundering Committee (NAMLC), the Federal Financial Institutions Examination Council (FFIEC), the Financial Transactions and Reports Analysis Centre (FINTRAC), etc.) can access that data so they can monitor Giori Money transfers as required to prevent abuses of the GSMT.

The middle level 602 of data includes Central Banks 104. All data regarding Giori Money transfers between the entities/devices 106-118 and 130 within the services network 100 flows to the Central Banks 104. Each individual Central Bank 104 can access that data so they can monitor Giori Money transfers as required to help regulate and control the flow of their own Giori Money within the GSMT and to develop and maintain their own monetary policies. A Central Bank 104 can gather all the data for the transfers in its respective region each day and effectuate Giori Money transfers to other Central Banks 104 and/or commercial banks 106 to make net positive payments. For example, a commercial bank 106 in a region covered by a first Central Bank 104 makes a payment of $25,000 to a retail establishment 108 in a region covered by a second Central Bank 104, and the commercial bank 106 in the region covered by the first Central Bank 104 receives a payment of $15,000 from a mobile device 130 in the region covered by the second Central Bank 104, the first Central Bank 104 will of the second Central Bank 104 $10,000 at the end of the day. Thus, the first Central Bank 104 will effectuate a single Giori Money transfer in the amount of $10,000 to the second Central Bank 104 instead of the first Central Bank 104 making a Giori Money transfer of $25,000 and the second Central Bank 104 making a Giori Money transfer of $15,000. Such data gathering and payment pooling helps reduce the number of overall Giori Money transfers performed each day, thereby making the GSMT more efficient.

In the alternative, Central Banks 104 can effectuate Giori Money transfers as they occur. The high level of automation provided by the GSMT makes such real-time transfers efficient despite the high volume of Giori Money transfers that will need to be effectuated each day. Any of the other entities/devices 106-118 and 130 within the services network 100 can also use one or both of those techniques to effectuate Giori Money transfers, including mobile devices 130.

The lower level 604 of data includes the various entities/devices 106-118 and 130 within the services network 100 where most Giori Money transfers are initiated. Because the Giori Money of the present invention is fungible, those entities/devices 106-118 and 130 can make Giori Money transfers directly between each other by exchanging data. For example, when a user is storing Giori Money on its mobile device 130, it can transfer that Giori Money to any other entity/device 106-118 in real time via an electronic communication that includes the actual Giori Money with its encrypted/encoded serial numbers and electronic watermarks. Or when that Giori Money is in a savings or checking account at a commercial bank 106 or in a virtual savings or checking account, a user can make a Giori Money transfer from that account to any of the entities/devices 106-118 and 130 within the GSMT. For example, a user can use a mobile device 130 to effectuate a Giori Money transfer from its account at a commercial bank 106 to a retail establishment 108, an ATM 112, a personal computing device 114, or even another mobile device 130. And that commercial bank 106 can gather and pool the data for all such transactions to make net positive payments, just as discussed above with respect to the middle level 602 of data.

At each level 600, 602, and 604 of data, more secure data protection techniques (e.g., encryption, tokenization, masking, etc.) will be used according to the sensitivity of the data at each level. For example, the data aggregated by the watchdog functionality 122 at the upper level 600 is the most sensitive because it covers all national and international transactions. Accordingly, the upper level 600 utilizes the most secure data protection techniques. The lower levels 602 and 604, while also employing advanced data protection techniques, need not be as secure as the upper level 600. Coupled with that security, the flow of data facilitated within the services network 100 makes the GSMT a very good platform for international agencies, federal agencies, Central Banks 104, and commercial banks 106 to monitor and effectuate money transfers. Moreover, it facilitates cooperation between those entities.

Turning to FIGS. 7 and 8, the first part of making a Giori Money transfer is registering with the MTS Provider during a registration process 800. A Customer can register with the MTS Provider by accessing the Customer's Management System 522 functionality of the central services server 102 via the Customer Portal 518, which provides a graphical user interface that the Customer uses to input the data required to effectuate Giori Money transfers. The Customer can use a personal computing device 114 or an application on a mobile device 130 to access the Customer's Management System 522 functionality and input the required data. In the alternative, the Customer can obtain paper forms (e.g., printing forms from the MTS Provider's web page, receiving forms via ground mail or facsimile, etc.) and register by completing those forms and using ground mail or facsimile to return the completed documents to the MTS Provider. A Customer may also obtain, complete, and/or submit the required forms via e-mail or an application on a mobile device 130.

Retail establishments 108 (e.g., supermarkets, clothing stores, convenience stores, private schools, etc.) can register themselves within the services network 100 so they can send and receive Giori Money in exchange for various goods and services. Payors 110 (e.g., employers, insurance companies, etc.) can register themselves within the services network 100 so they can send Giori Money to their payees (e.g., employees, beneficiaries, etc.). And anyone owning a mobile device 130 can register himself or herself within the services network 100 so he or she can use his or her mobile device to send and receive Giori Money to and from commercial banks 106, retail establishments 108, payors 110, ATMs 112, and other people with mobile devices 130.

Anyone with a mobile device 130 can register himself or herself within the services network 100 because the functionality of the present invention preferably uses a communication service that is available on almost every mobile device 130, such as Short Message Service (SMS) and General Packet Radio Service (GPRS). The cellular service provider 128 need not register itself within the services network 100 of the GSMT for its customers to utilize the Giori Money transfer functionality of the GSMT, it only needs to support the communication service being utilized. However, cellular service providers 128 should still be motivated to register themselves within the services network 100 so they can receive Giori Money in exchange for their services. Moreover, by registering with the MTS Provider, any related services offered by the cellular service providers 128 can be better integrated into the services network 100 via that relationship.

Depending on who operates them, ATMs 112 may already be part of the services network 100 or they may need to be registered with the MTS Provider to become part of the services network 100. For example, the MTS Provider can provide the ATMs 112, in which case they will already be integrated into the services network 100, as discussed above. Or commercial banks can provide the ATMs 112, in which case they will be part of the core banking system that is already integrated into the services network 100. Or the ATMs 112 can be privately owned and operated, in which case the owner will have to register with the MTS Provider to have them integrated into the services network 100. Each type of ATM 112 may be present within the services network 100. And, preferably, anyone will be able to use the ATMs 112 within the services network 100 with no ATM access fees, much like ATMs 112 in the Global ATM Alliance. But unlike the ATMs in the Global ATM Alliance, a person need not be a customer of a specific bank, or even have a bank account, to use the ATMs in the GSMT.

As part of the registration process 800, a Customer (i.e., a retail establishment 108, payor 110, ATM 112, cellular service provider 128, and/or owner of mobile a device 130) inputs its personal data at step 802. For example, a retail establishment 108 or payor 110 will input its name, physical address, e-mail address, proof of identity (e.g., proof of incorporation), and information for an account into and/or from which Giori Money is to be withdrawn and/or deposited (e.g., bank identification, account number, routing number, etc.). And an owner of a mobile device 130 will input his or her name, birth date, physical address, e-mail address, proof of identity (e.g., social security number), and information for the mobile device 130 to and/or from which Giori Money will be sent and/or received (e.g., mobile telephone number).

After a Customer has input its personal data at step 802, the central services server 102 generates a password and sends it to that Customer electronically at step 804. For example, a retail establishment 108 or payor 110 may receive an e-mail at a mobile computing device 114 using the e-mail address it input. And an owner of a mobile device 130 may receive an SMS text message, or comparable message (e.g., application-to-person (A2P) message, GPRS message, etc.), at the mobile device 130 using the mobile telephone number he or she input. The central services server 102 sends an SMS text message to a mobile device 130 via its interface with a mobile network hub 116, which includes an SMS gateway that transforms the electronic message sent by the central services server 102 into an SMS text message before routing it to the mobile device 130 via the appropriate cellular service provider's 128 cellular network.

After the Customer receives its password at step 804, it must access the Customer's Management System 522 functionality again and confirm the password at step 806. The Customer can use a personal computing device 114 or an application on a mobile device 130 to access the Customer's Management System 522 functionality and input the password. The Customer will be required to input the password within a short period of time to confirm the Customer's link to the information input at step 802. When a mobile device 130 is to be used to send and receive Giori Money, that link is preferably confirmed via SMS text message to that mobile device. The Customer can also create its own password at that time, replacing the password generated by the central services server 102 with a password that is personalized by the Customer. As a result, that Customer will be registered within the services network 100 of the GSMT.

In geographic areas where the MTS Provider is required to store paper copies of each Customer's registration information, the appropriate forms can be auto-populated and printed using the data input into the central services server 102, or the MTS Provider can require the Customers to submit original signed copies of those forms. And the amount and type of information collected during the registration process 800 can be varied as required to satisfy local laws in different geographic areas. As a result, a Customer may be required to designate any geographic area where it intends to effectuate Giori Money transfers during the registration process 800. Based on those designations, the central services server 102 will automatically require the Customer to input the appropriate information for each of those geographic areas during the registration process 800 so as to ensure the legality and security of any Giori Money transfers that may be effectuated in those geographic areas.

After a Customer is registered in the services network 100, it can send and/or receive Giori Money to and/or from any other Customer that is registered in the services network 100. For example, a payor 110 can transfer Giori Money to a payee that owns a mobile device 130, that payee can transfer at least a portion of that Giori Money to a retail establishment 108, and/or that payee can transfer at least a portion of that Giori Money to another person who owns a mobile device 130. Unlike conventional mobile money transfers, the services network 100 of the GSMT allows those Giori Money transfers to be effectuated across large geographic areas and between substantially any cellular service providers' 128 cellular networks. Moreover, because the Giori Money being transferred is guaranteed by Central Banks 104, it is fungible across those large geographic areas.

But before a Customer can send Giori Money via the services network 100 of the GSMT, Giori Money must be issued into the services network 100 by an issuing party at step 808. Giori Money is issued into the services network 100 in a similar manner to that in which banknotes are issued into circulation so that Central Banks 104 may regulate and control the flow of the Giori Money. For example, a Central Bank 104 will go to the open market and buy financial assets (e.g., government bonds, gold, etc.) to back any Giori Money issued into the GSMT. It may also be advantageous for a Central Bank 104 to back Giori Money with banknotes by taking those banknotes out of circulation in exchange for its financial assets. Accordingly, Central Banks 108 can not only regulate and control the value and flow Giori money, they can also regulate and control the value and flow of banknotes, which allows them to better implement their monetary policies, such as preventing inflation.

For ease of use and understanding, Giori Money will preferably be issued into the services network 100 in the same denominations as the banknotes issued in the country of the Central Bank 104 guaranteeing the Giori Money (e.g., ¢1, ¢5, ¢10, ¢25, $1, $2, $5, $10, $20, $50, $100, etc. in the Unites States). That Giori Money is issued into the services network 100 electronically by inputting individually-valued elements of data into the services network 100.

And to prevent counterfeiting and/or laundering, issuing parties (e.g., Central Banks 104, commercial banks 106, post offices, MTOs, cellular service providers, etc.) will encrypt/encode each individually-valued element of data (hereinafter “virtual banknote”) with a serial number that is unique to that virtual banknote and an electronic watermark that authenticates that banknote as validly issued tender. Those encrypted/encoded virtual banknotes are what make up Giori Money. And because that encryption/encoding will necessarily be proprietary to each issuing party, it is not discussed in more detail hereinafter.

After Giori Money has been issued into the services network at step 808, a Customer can begin the remittance process 810. A Customer begins the remittance process 810 at step 812 by requesting a remittance of a specific amount of Giori Money. For example, a payor 110 can request a remittance of Giori Money to a payee from the commercial bank 106 where that payor 110 maintains an account. And because the Giori Money held and/or issued by that commercial bank 106 is guaranteed by the pertinent Central Bank 104, it is convertible on par with banknotes of the same denomination such that the money in the payor's account can be withdrawn as either banknotes or Giori Money. In other words, the value of money in the payor's account can be represented, and therefore withdrawn, as either banknotes or Giori Money because of the fungible and interchangeable nature of those two forms of nature.

A Customer can request a remittance of Giori Money by accessing the Customer Account Manager 524 functionality of the central services server 102 via the Customer Portal 518, which provides a graphical user interface that the Customer uses to input the amount of Giori Money it wants to transfer. The Customer can use a personal computing device 114 or an application on a mobile device 130 to access the Customer Account Manager 524 functionality and input the required data. And, in the example of a payor 110, the Customer can set up his or her Customer Account to automatically request and make Giori Money transfers to specific parties at specific times, such as for automatic payroll dispersements.

A Customer can also obtain Giori Money by depositing banknotes with a commercial bank 106, retail establishment 108, or ATM 112. For example, the Customer can go to a retail establishment 108 (e.g., a post office, a cellular service provider retail outlet, etc.) and exchange banknotes for Giori Money. The Customer can then have that Giori Money transferred to a virtual savings or checking account or to its mobile device 130 by way of the SIM Card that is unique to the Customer and mobile device 130. In that way, a Customer can transfer GSMT

Money to its mobile device 130 in the GSMT in a similar manner that people can credit mobile scrip to their mobile devices 130 in conventional mobile money systems, except that Giori Money is fungible while mobile scrip can only be exchanged with other customers of the same cellular service provider and the entities (e.g., banks, retailers, agents, local service providers, etc.) that have partnered with that cellular service provider.

Depending on a Customer's credit rating, that Customer may also be able to make a Giori Money transfer without placing any of its own Giori Money in the system. For example, the MTS provider can extend the Customer credit to make the transfer, or the Customer can use a credit card to make the transfer. The Customer can subsequently repay the MTS provider or credit card company, with either banknotes or Giori Money.

In response to a request for a remittance of Giori Money at step 812, the Accounting and Reconciliation module of the central services server 102 validates the request at step 814. For example, the Accounting and Reconciliation module will make sure the requesting Customer is allowed to make Giori Money transfers (i.e., make sure that the Customer has not been black-listed from making such transfers), make sure that Customer has the requested amount of Giori Money to be transferred, and make sure the requested amount of Giori Money to be transferred does not exceed any predetermined upper limits, such as those set by the Customer,

the MTS Provider, or a pertinent governing body. The central services server 102 will also implement its watchdog functionality 122 and Fraud Detection Engine 536 to try to identify any potential abuses of the services provided by the GSMT.

Upon validating the Customer's request for a remittance at step 814, the Customer will input information identifying the recipient of the Giori Money transfer at step 816. For example, a payor 110 can identify a payee that owns a mobile device 130 as the recipient of the Giori Money transfer by accessing the Transaction Manager 526 functionality of the central services server 102 via the Customer Portal 518, which provides a graphical user interface that the Customer uses to input the mobile telephone number of that mobile device 130. The Customer can use a personal computing device 114 or an application on a mobile device 130 to access the Customer's Management System 522 functionality and input the required data.

After the desired recipient of the Giori Money transfer has been identified at step 816, the central services server 102 effectuates the transfer of Giori Money to the recipient via one of its interfaces at step 818. For example, the central services server 102 will transmit the Giori Money to a mobile device 130 via its Cellular Service Provider Interface 508, which allows the central services server 102 to transmit transactional data to a mobile device 130 via a mobile network hub 116 that translates that data into an SMS text message. As the Giori Money transfer is effectuated, the Accounting and Reconciliation functionality records and stores all of the pertinent information regarding that transaction, such as the parties involved, the amount transferred, etc. The recipient of the SMS text message also receives the encryption/encoding information for each virtual banknote that makes up the Giori Money transferred to his or her mobile device 130, thereby effectuating the electronic transfer of fungible currency. And although an SMS text message is described as the mechanism for sending such data, other suitable mobile communications services may also be used as required to send the desired type of information (e.g., GPRS, Multimedia Messaging Service (MMS), Wireless Application Protocol (WAP), etc.).

A Customer receives a Giori Money transfer at step 820. That Customer will receive an electronic notification that it received the Giori Money, such as an e-mail or an SMS text message. When the Giori Money transfer is to a mobile device 130, the electronic notification is preferably via SMS text message or other suitable mobile communications service. Because the Giori Money transferred is fungible currency, just like banknotes, the recipient of the Giori Money transfer advantageously does not need a bank account or a credit card to receive or spend that Giori Money. Instead, the recipient's mobile device 130 serves as a virtual wallet in which he or she carries that fungible currency, which is of particular usefulness to the unbankable and unbanked. But unlike a real wallet, the recipient of the Giori Money can password protect their mobile device 130 to protect the Giori Money stored therein should he or she inadvertently fall out of possession of his or her mobile device 130, which provides yet another advantage over conventional money transfers. In the alternative, the central services server 102 of the GSMT can utilize its enterprise DBMS in conjunction with the functionality of its Data Warehouse Engine 542 and Archiving and Backup module 544 to store and keep track of each Customer's Giori Money in a virtual savings or checking account so it does not need to be stored on a mobile device 130 and, instead, can be easily retrieved from the central services server 102 with a mobile device 130 by withdrawing it from that virtual account using the functionality of the Transaction Manager 526.

If the Giori Money transfer is sent from a first geographic area 700 (e.g., somewhere in the United States) at step 818 and received in a different geographic area 702 (e.g., Sudan, Africa) and those two geographic areas 700 and 702 utilize different types and denominations of currency (e.g., U.S. dollars versus Sudanese pounds), the central services server 102 will automatically exchange the sender's type and denomination of Giori Money for an equivalent amount of the recipient's type and denomination of Giori Money as part of that transfer. That automatic currency exchange is carried out by effectuating a remittance 810 of the sender's Giori Money to a commercial bank 106 or a retail establishment 108 (e.g., an MTO, foreign currency exchange service, etc.) that provides such services and then making another remittance 810 of the exchanged Giori Money to the recipient (i.e., step 818 results in the Giori Money being rerouted to the party providing the exchange service and the party providing the exchange service performs steps 812-818 again after exchanging the Giori Money to the desired currency). Such commercial banks 106 and retail establishments 108 will maintain sufficient amounts of different types and denominations of Giori Money, just as they would different types and denominations of banknotes, and will apply the appropriate exchange rates when providing their exchange services. That functionality of the present invention provides the advantage of eliminating the need for the sender or recipient of Giori Money to physically travel to an establishment that exchanges money in order to send or receive money to or from geographic areas 700 and 702 that utilize different types and denominations of currency. Moreover, it allows the recipient to immediately use the received Giori Money in the geographic area in which it was received. For example, the recipient can immediately effectuate a transfer of that mobile to an ATM 112 and withdraw banknotes of the desired type and denomination (e.g., steps 824-828).

The automated currency exchange functionality of the present invention is necessary because the Giori Money of the present invention is fungible currency guaranteed by Central Banks 104. Accordingly, it represents the liabilities of the Central Bank 104 that guarantees it such that a Central Bank 104 in one geographic area 702 will not be obligated to honor the liabilities of a Central Bank 104 in another geographic area 700. In other words, the Giori Money guaranteed by Central Banks 104 in different countries will be treated in the same way as banknotes guaranteed by Central Banks 104 in different countries. But unlike banknotes, the functionality of the present invention fully automates the exchange of different types and denominations of currency so as to eliminate the need to physically exchange the currency.

The functionality of the present invention also fully automates the exchange of Giori Money between Central Banks 104, thereby allowing those Central Banks 104 to control international trade flows as required correct positive trade balances and to implement their respective monetary policies, such as preventing inflation. Moreover, it provides functionality for tracking those exchanges and the corresponding transfers so the Central Banks 104 in different geographic areas 700 and 702 can better regulate and control those trade flows. To facilitate that tracking functionality, information on the total amount of Giori Money being transferred within the services network 100 as well as its origin and destination is preferably aggregated by the central services server 102 on a daily basis.

The automated currency exchange functionality of the present invention is also particularly useful when travelling abroad. For example, the owner of a mobile device 130 can carry that mobile device from one geographic area 700 to another 702 and the E-wallet functionality 120 of the present invention will automatically recognize the geographic area 702 in which the mobile device 130 is now located and display to the owner of that mobile device 130 exactly how much Giori Money he or she possesses in the currency of that geographic area 702. In other words, a currency handover will occur between different types and denominations of currency as a mobile device 130 is moved from one geographic area 700 to another 702 just as a cellular service handover will occur between different cellular service providers 128 as the mobile device 130 is moved from one geographic area 700 to another 702. However, that currency handover is symbolic only (i.e., it is only displayed to the owner of the mobile device 130 via the E-wallet functionality) so that the owner of the mobile device 130 does not incur fees for exchanging all of the Giori Money in his or her E-wallet every time he or she moves from one geographic area 700 to another 702. Instead, an exchange of his or her Giori Money will only occur as discussed above when he or she makes a Giori Money transfer in that other geographic area 700, thereby limiting the actual amount of Giori Money exchanged into a different type and denomination of currency to the actual amount transferred while the owner of the mobile device 130 is in that other geographic area 700.

The currency handover of the present invention primarily serves as a convenience for the owner of the mobile device 300 to quickly and easily determine how much Giori Money of a specific type and denomination he or she is carrying in his or her E-wallet in different geographic areas 700 and 702. It also limits the amount of Giori Money exchanged from one currency to another to the amount actually transferred/spent while he or she is in a different geographic area 702. And the automated currency exchange functionality of the present invention serves to actually effectuate an exchange of Giori Money from one currency and denomination to another. Together, that functionality not only allows a Customer to conveniently exchange Giori Money from one currency and denomination to another when making a Giori Money transfer from one geographic 700 area to another 702, it also allows a Customer to conveniently carry Giori Money from one geographic 700 area to another 702 on a mobile device 130 and to exchange it only as it is transferred/spent in that other geographic area 702. It is envisioned, however, that the other functionality of the present invention will facilitate the adoption of a unified world currency such that the same type and denomination of currency is adopted throughout the services network 100, thereby eventually eliminating the need for the automated currency exchange and currency handover functionality discussed above.

It should also be understood that, because the Giori Money is issued in specific denominations (e.g., $5, $10, $20, etc.), a recipient of a Giori Money transfer may need to make a return transfer of any value of Giori Money exceeding the amount intended to be transferred. For example, a retail establishment 108 may need to make change for a buyer of their goods or services in response to receiving a specific denomination of Giori Money at step

820. In that case, the retail establishment 108 will need to make a remittance 810 back to a buyer of their goods or services. For example, a buyer may use his or her mobile device 130 to purchase a good that costs $10.75. If the buyer only has Giori Money in the form of a $20 virtual banknote in his or her E-wallet, the retail establishment 108 will automatically transfer a $5 virtual banknote, four $1 virtual banknotes, and a ¢25 virtual banknote (i.e., $9.25 in Giori Money) back to the mobile device 130 in exchange for the $20 virtual banknote. In the alternative, the buyer can use his or her mobile device 130 to effectuate a transfer from a party that issues Giori money (e.g., Central Bank 104, commercial banks 106, post offices, MTOs, cellular service providers, etc.) in the exact amount owed. Or, as yet another alternative, the exact amount owed can be deducted from the Giori Money in the buyer's E-wallet with that Giori Money being re-encrypted/re-encoded into the appropriate denominations based on the deduction (e.g., electronically transforming a $20 virtual banknote into $9.25 in Giori Money).

Those transactions will be automatically conducted by the central services server 102 and preferably occur in the background of any operation utilized to effectuate the purchase. In that way, the buyer need only designate the amount of Giori Money he or she wishes to transfer with his or her mobile device 130 rather than designate specific virtual banknotes to transfer.

Moreover, the E-wallet functionality 120 of the central services provider 102 need only indicate to the buyer the total amount of Giori Money in his or her E-wallet rather than listing the specific virtual banknotes in his or her E-wallet, thereby making the Giori Money of the present invention much easier to use than actual banknotes. The Giori Money of the present invention must be exchanged in that manner so that the encryption/encoding required prevents counterfeiting and/or laundering and that Giori Money remains intact. It also allows the transfer of that Giori Money to be tracked more accurately by the Central Banks 104 controlling it.

If the recipient of a Giori Money transfer desires banknotes instead of Giori Money, it can utilize a banknote exchange process 822 to exchange the Giori Money for a corresponding value in banknotes. To begin the exchange process 822, the Customer that received that Giori Money transfer requests an exchange of that Giori Money into banknotes at step 824. The Customer can request such an exchange by accessing the Customer Account Manager 524 functionality of the central services server 102 via the Customer Portal 518, which provides a graphical user interface that the Customer uses to input the amount of Giori Money it wants to exchange for banknotes. The Customer can use a personal computing device 114 or an application on a mobile device 130 to access the Customer Account Manager 524 functionality and input the required data.

In response to a Customer's request for an exchange of that Giori Money into banknotes at step 824, the Code Generation Engine 528 of the central services server 102 will automatically generate a one-time transaction code, or Personal Identification Number (PIN), and send it to that Customer electronically at step 826. For example, the owner of a mobile device 130 may receive an e-mail, an SMS text message, or a comparable message (e.g., application-to-person (A2P) message, GPRS message, etc.) at his or her mobile device 130. The central services server 102 sends an SMS text message to that mobile device 130 via its interface with a mobile network hub 116, which includes an SMS gateway that transforms the electronic message sent by the central services server 102 into an SMS text message before routing it to the mobile device 130 via the appropriate cellular service provider's 128 cellular network. The message sent to the mobile device 130 may also include other information that is relevant to the transaction, such as the amount of Giori Money requested to be exchanged into banknotes, the party requesting the exchange, the time and date of the request, and any other information that may be required to effectuate the request.

After the Customer receives the one-time PIN generated at step 826, it can go to any ATM 112 within the services network 100 and withdraw banknotes at step 828. The Customer withdraws the banknotes by entering the one-time PIN, as well as any other required information, into the ATM 112 within a predetermined period of time. The ATM 112 communicates with the central services server 102 via an ATM Channel Adapter 516 at the central services server 102, and the central services server will signal to the ATM 112 whether or not the withdrawal of banknotes is approved based on the information the Customer inputs into the ATM 112. For example, the central services server 112 will verify that the PIN is correct, that the request for an exchange of Giori Money to banknotes exists, that the amount complies with local laws and/or a Customer's personal settings, and that any information entered into the ATM by the withdrawing party matches the information input into the central services server 102 by the requesting party. And because the PIN is a “one-time” PIN, it will only be valid for that single banknote withdrawal.

In addition, the central services server 102 will automatically make a remittance 810 of the Customer's Giori Money to the party operating the ATM 112 in an amount equivalent to the banknotes withdrawn from the ATM 112. If the banknotes are of a different type and denomination of currency than the Giori Money being transferred, the central services server 102 will also automatically exchange the Giori Money into a type and denomination that corresponds to the banknotes withdrawn from the ATM 112 using the currency exchange functionality discussed above. In that way, the operator of the ATM 112 receives Giori Money in an identical type and denomination to the banknotes withdrawn by the Customer, which prevents the operator of the ATM 112 from having to exchange that Giori Money itself. And that convenience will further encourage the operators of ATMs 112 to become a part of the services network 100 of the present invention, if they are not already.

To provide greater access to ATMs 112 for making such transfers and withdrawals, ATMs 112 may be provided in kiosks in rural communities and integrated into the services network 100 via wireless data communication (e.g., wireless local area network (WLAN), satellite network, cellular network, etc.). To provide additional access to banking, such ATMs 112 may also include functionality for interacting with the PMSB or a commercial bank 106, whereby a user can open and/or manage a savings account and/or checking account with the PMSB or commercial bank 106 via those ATMs 112. And to provide greater security, use of such ATMs 112 may require a user to provide a government sponsored national ID card with fingerprint or iris information that must be verified against the user's iris or fingerprint at the ATM 112 with an iris or fingerprint scanner. Such a requirement should not significantly limit access to such ATMs 112 because many countries already issue, or are expected to begin issuing, such national ID cards to their citizens on a mandatory basis (e.g., Belgium, Brazil, Czech Republic, Egypt, Germany, South Africa, Turkey, etc.). In fact, the many benefits provided by the present invention will encourage people to obtain such national ID cards, which will help those countries more effectively implement the issuance of such national ID cards to their citizens, particularly in countries where such cards are not mandatory (e.g., France, Sweden, Switzerland, the United States, etc.). In addition to the use of the SIM card of a mobile phone, any biometric identification means can be integrated in the said mobile phone in order to take care that the user of the mobile phone while asking for and/or obtaining the transferred electronic/digital money is its real owner. Any biometric features such as iris, fingerprint or facial recognition may be used depending on the country and on its specific regulations or traditions.

As another example of the functionality of the GSMT, a Customer can also request that a party other than itself be able to withdraw banknotes at step 828. To do so, the customer designates that other party as the recipient when requesting an exchange of Giori Money into banknotes at step 824. Such a designation will initiate a new remittance process 810, wherein the request (step 812/824) must be validated (step 814) and the other party who will withdraw the banknotes must be identified (step 816). Then, instead of sending the identified party Giori Money (step 818), that Giori Money will be sent to the operator of the ATM 112 from which the identified party will withdraw an equivalent amount in banknotes at step 828. And the identified party will receive the one-time PIN, as well as any other information required to make a withdrawal from the ATM 112 (e.g., the identity of ATMs 112 operated by the party that received the equivalent amount of Giori Money) at step 826, which will allow him or her to withdraw that equivalent amount in banknotes from the ATM 112 at step 828. The requesting party may also receive a message, such as an e-mail or SMS text message, that informs that party if and when the requested transaction is completed.

In a more specific example, a Customer can go to a retail establishment 108 within the services network 100 and exchange banknotes for Giori Money. The Customer may also write a check, use a credit card, or use any other method of providing value in exchange for the Giori Money. That Customer can request that the retail establishment transfer the Giori Money to his or her mobile device 130 or even to another party's mobile device 130 using the remittance process 810. Or the Customer can request that the Giori Money be transferred to the operator of an ATM 112 using the remittance process 810 so that the Customer or another party can withdraw banknotes in an equivalent amount to the Giori Money in a banknote exchange process 822. In the latter instance, the Customer or the designated other party may receive a voucher with the one-time PIN at step 826, which will allow them to withdraw banknotes from an ATM 112 at step 828. And if the Customer requests that another party be able to withdraw the money from an ATM 112, the Customer can receive the message with the one-time PIN and forward it to the other party, or the Customer can elect to have the message with the one-time PIN sent directly to that other party with the requesting Customer only receiving a confirmation message that the one-time PIN was sent to the other party.

Those processes are particularly useful for transferring money from a Customer in one geographic area 700 to an unbanked party in another geographic area 702. For example, a Customer in the United States 700 can obtain Giori Money from a retail establishment 108 or a payor 110 and request that it be exchanged into banknotes for another party to withdraw from an ATM 112 in Africa 702. All the party in Africa 702 needs is a mobile device 130 to withdraw those banknotes from the ATM 112. The party in Africa will receive a message with the onetime PIN via an SMS text message and can simply go to the appropriate ATM 112 and withdraw the banknotes with the information in that SMS message. No bank account or credit card is needed.

If party withdrawing banknotes from an ATM 112 must be authenticated based on the corresponding regulations and/or laws in the geographic area 700 or 702 where the banknotes are being withdrawn, the withdrawing party may be asked to send an SMS text message back to central services server 102 with his registered mobile device 130 before that party can withdraw banknotes from the ATM 112. That return SMS message can occur via the same channels as were used by the central services server 102 to send an SMS text message to the withdrawing party. If the mobile telephone number of the mobile device 130 is registered within the services network 100 and is not black listed, the central services server 102 will then send an SMS text message back to the withdrawing party containing a one-time PIN. At the ATM 112, the withdrawing party will be asked to authenticate the transaction by entering his mobile number and the one-time PIN. If the authentication succeeds, the withdrawing party will then be allowed to proceed with the withdrawal.

In its simplest form, the GSMT can be implemented by providing retail establishments 108 in one geographic area 700 and proprietary ATMs 112 in another geographic area 702. In that way, a Customer in one country need merely go to one of those retail establishments 108 and request a remittance to an ATM 112 in the other geographic area 702. Then, the Customer can send any party in that other geographic area 702 an SMS text message with the one-time PIN required to withdraw banknotes from that ATM 112 using the authentication techniques discussed above.

To facilitate the SMS text messaging that will need to occur from one geographic area 700 to another 702, the mobile network hub 116 of the GSMT is preferably provided by an international wholesaler to further reduce the costs of the Giori Money transfers of the present invention. And to effectuate and track Giori Money exchanges in those different geographic areas 700 and 702, the central services server 102 is integrated with and able to remotely manage international transactions with other central services servers 102′ located in several countries with a wide range of full-IP communication solutions. The central services server 102 also supports virtual banking functionality 124 that not only allows the MTS Provider to track and make an accounting of international money transfers for the purposes of operating the services network 100 in accordance with the applicable laws and regulations, it also allows Central Banks 104 to track and make an accounting of international money transfers so they can better control and regulate the flow of money.

The virtual banking functionality 124 and the Accounting and Reconciliation module 540 of the present invention record and reconcile each of the transactions performed by the present invention so as to keep track of the Giori Money being exchanged within the services network 100 and to provide an individual accounting to each Customer. Accordingly, each Customer can easily access a record of its transaction via its 518 for its own accounting purposes. Moreover, Central Banks 104 can track each transfer of Giori Money so they can more easily regulate and control the flow of that currency.

A user's various interactions with the various entities/devices 106-118 and 128-134 within the services network 100 are facilitated, for example, by user interfaces at ATMs 112, personal computing devices 114, and mobile devices 130. Those graphical user interfaces may incorporate pictograms that can be easily understood by illiterate people so as to provide even greater access to the benefits of the present invention.

As is evident from the disclosure above, the present invention overcomes the shortcomings of the prior art by providing an efficient, reliable, affordable, and accessible system and method for transferring fungible currency. Moreover it eliminates traditional remittance players and financial institutions, such as banks, credit card issuers, and MTOs, from the remittance process. Eliminating those players and financial institutions greatly reduces the costs typically associated with the remittance process and makes the present invention particularly suited for people who are unbankable or unbanked. Those costs are further reduced by the automation of the present invention, which limits human intervention along the provisioning chain.

The present invention provides a low cost alternative to both nationals in their home countries and immigrants living in diaspora communities throughout the world. The present invention reduces the costs of such transactions and makes financial and banking services more readily accessible to the “unbanked” and “unbankable” populations in developing countries. The present invention also provides a platform for Central Banks, commercial banks, and various national and international agencies to monitor money transfers as required to control the flow of money, develop monetary policies, and identify potential abuses.

In addition, by implementing the open loop system of the present invention globally, it allows MTOs to function more effectively and encourages MTOs and cellular service providers to communicate and share information between systems to provide money transfer services, just as cellular service providers have done with each other to provide roaming services for mobile telephones. Such cooperation results in a highly flexible open loop system that provides advantages for all of those who participate. Moreover, it provides opportunities for micro-financing low-income people and, therefore, the development of business and industry in developing countries, particularly those where physical cash transfers are difficult.

Further still, by forming a holding company made up of international banks and Central Banks 104 that will control the PMSB of the present invention, the GSMT not only ensures that the appropriate banking laws and regulations are complied with while effectuating Giori Money transfers, it also provides users with various other useful banking services, all of which can be accessed via a vast network of ATMs 112. Moreover, banks generally do not like to use their own names when venturing into new areas of banking, such as branchless banking. So forming a holding company allows those banks to provide services within the GSMT without lending their name to the GSMT. Such a holding company may be formed “offshore” to provide financial and legal advantages to its members, and it will also allow banks to engage in certain non-banking activities, as may be required to provide certain services within the GSMT.

The know-how contributed by the banks of the holding company, as well as the services they provide, can be sold to commercial banks 106, MTOs, and cellular service providers so that those entities can also take advantage of that know-how and those services. Although MTO systems and mobile money systems have proven capable of effectuating money transfers, integrating those MTO systems and mobile money systems with banks in that manner makes such transfers far more accessible, such as by incorporating the vast network of ATMs provided by those banks. Moreover, Central Banks 104 are more inclined to deal with banks than with MTOs and cellular service providers, so including international banks and commercial banks 106 in the GSMT as described will further encourage Central Banks 104 become a part of the services network 100. As discussed above, the Central Banks 104 will also be encouraged to become part of the services network 100 because the infrastructure of the services network 100 will allow them to better track and control the flow of money.

In summary, one of the functions of the GSMT is designed to be compatible with existing money transfer systems and banking systems to offer unlimited possibilities for making money transfers. Furthermore, it is a globally standardized system that complies with federal and international banking regulations. One or more official government bodies monitor and track the flow of money within the GSMT to prevent potential abuses. And by forming such an open loop system, cellular service providers and MTOs can exchange information freely so that their customers no longer need corresponding carriers to send/receive money. Moreover, whether used in money transfers or everyday transactions, GSMT is a government tool and a globally accepted architecture that also includes the generation of codes which can eventually be used to replace banknotes (paper currency) within the structure, supervision and control of Central Banks.

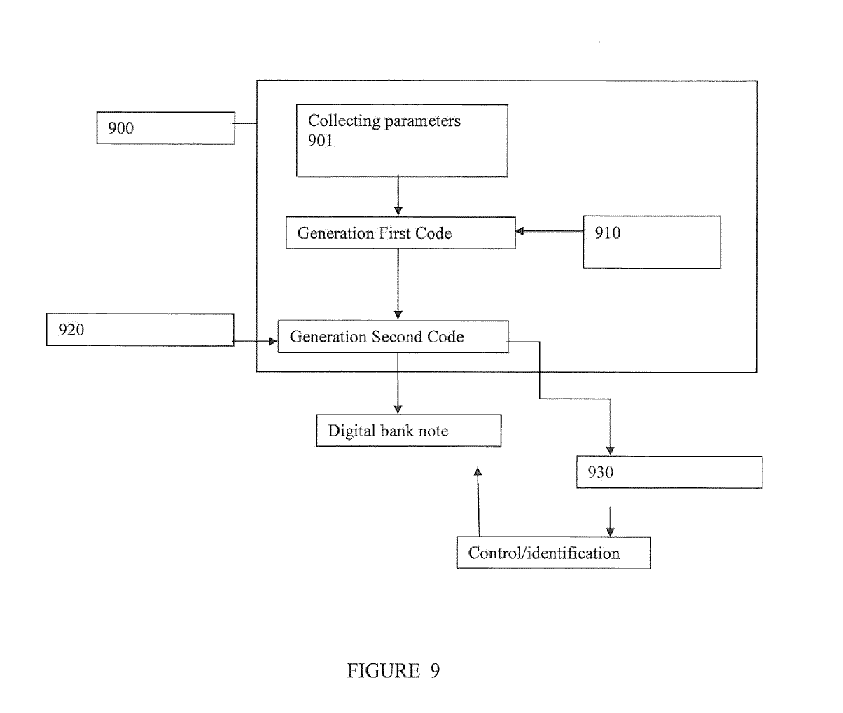

FIG. 9 is a flow chart illustrating an exemplary implementation of an implementation of a system and of a method in accordance with the present invention. The method for generating fungible electronic money comprises several specific steps.

A step consists in collecting physical and/or numeric parameters of an existing bank note, for instance by using electronic, optical and mechanical system 900. This collecting step is for instance based on scanning operations operated by scanning means 901.

Another step consists in using a first algorithm 910 for generating a first code based on at least some of the collected parameters.

Another step consists in using a numbering algorithm 920 for generating an unique code number. The numbering algorithm 920 is advantageously owned and known only by a corresponding central bank.

Another step consists in combining the first code with the code number and generating a unique second code which integrates data of the collected parameters. This second code is called for instance G-CODE or GIORI-CODE.

This second code is then attributed to an electronic/digital bank note which can be identified without any risk of false identification.

In an implementation of the method in accordance with the invention, the first algorithm which generates a random code and the numbering algorithm which generates an unique and random code number is combined to the first code in order to obtain the second code.

In an implementation of the method in accordance with the invention, the step of storing the second code on a safe and readable support 930, located in a safe environment, for instance a central bank.

In an implementation of the method in accordance with the invention, the step of using the second code for the identification of an electronic/digital bank note and for the authentication of a numeric transfer of electronic money.

The system 900 for carrying out the method in accordance to the invention comprises any means for collecting by reading or scanning physical and/or numeric parameters of an existing bank note. The existing bank note may be a physical bank note or stored numeric data defining such an existing bank note. The system 900 comprises also software means in which is stored the first algorithm 910, additional software means in which is stored the second algorithm 920 and preferably housed by a central bank. The system 900 comprises also readable and safe means for storing the second code 920. This readable and safe means are also housed by a central bank.

In an embodiment in accordance with the invention, the system 900 comprises communication means for establishing data communication between official controlling authorities such as central banks and electronic transaction systems and/or communication/banking networks, for supervising and controlling any transaction using electronic money.

The foregoing description and drawings should be considered as illustrative only of the principles of the invention. The invention may be configured in a variety of ways and is not intended to be limited by the preferred embodiment. And numerous applications of the invention will readily occur to those skilled in the art. It is therefore not desired to limit the invention to the specific examples disclosed or the exact construction and operation shown and described. Rather, all suitable modifications and equivalents may be resorted to, falling within the scope of the invention.

In the description above, the following abbreviations have been used:
ATM: automated teller machine
AML: anti money laudering
BIC: bank indentifier code
BIS: bank for international settlements
CFT: combating financial terrorism
CHAPS: clearing house automated payment system
CHATS: clearing house automated transfer system
CHIPS: Clearing House Interbank Payments System
CRM: customer relationship management
DBMS: database management system
DTMF: dual-tone multi-frequency
FATF: financial action task force
FDMA: frequency division multiple access
FFIEC: federal financial institutions examination council
FINTRAC: financial transactions and reports analysis centre
GPRS: general packet radio service
GSM: global system for mobile communications
GSMA: global system for mobile communications association
GSMT: Giori standard for money transfer or Giori secure money technology
IBAN: international bank account number
IMF: international monetary fund
IVR: interactive voice response
LTE: long term evolution
MMU: mobile money for the unbanked
MMS: multimedia messaging service
MTO: money transfer operator
MST: money transfer services
MTSO: mobile telephone switching office
NAMLC: national anti-money laundering committee
OFAC: office of foreign asset control
PDA: personal digital assistant
PBX: private branch exchange
PCM: pulse-code modulation
PIN: personal identification number
PLMN: public land mobile network
PMSB: people's mobile savings bank
PSTN: public switched telephone network
SIM: subscriber identity module
SMS: short message service
SWIFT: society for worldwide interbank financial telecommunication
VoIP: voice over internet protocol
VPN: virtual private network
WAP: wireless application protocol
WiMAX: worldwide interoperability for microwave access

Naturally, the present invention can be subjected to numerous variations as to its implementation. Although several embodiments and implementations are described above, it should readily be understood that it is not conceivable to identify exhaustively all possible variants. It is naturally possible to envisage replacing any of the means described or any of steps described with equivalent means or an equivalent step without going beyond the ambit of the present invention.

1-14. (canceled)

15. Method for generating fungible electronic money for an open looped system, comprising the steps of:
collecting physical and/or numeric parameters of an existing bank note,
using a first algorithm for generating a first code based on at least some of the collected parameters,
using a numbering algorithm for generating an unique code number,
combining the first code with the code number and generating a unique second code which integrates data of the collected parameters,
and attributing the second code to an electronic/digital bank note.

16. Method according to claim 15, comprising the step of using a first algorithm which generates a random code.

17. Method according to claim 15, comprising the step of using a numbering algorithm which generates unique and random code number which is combined to the first code.

18. Method according to claim 16, comprising the step of using a numbering algorithm which generates unique and random code number which is combined to the first code.

19. Method according to claim 15, comprising the step of storing the second code on a readable support within a safe environment.

20. Method according to claim 16, comprising the step of storing the second code on a readable support within a safe environment.

21. Method according to claim 17, comprising the step of storing the second code on a readable support within a safe environment.

22. Method according to claim 18, comprising the step of storing the second code on a readable support within a safe environment.

23. Method according to claim 15, comprising the step of using the second code for the identification of an electronic/digital bank note and for the authentication of a numeric transfer of electronic money.

24. Method according to claim 16, comprising the step of using the second code for the identification of an electronic/digital bank note and for the authentication of a numeric transfer of electronic money.

25. Method according to claim 17, comprising the step of using the second code for the identification of an electronic/digital bank note and for the authentication of a numeric transfer of electronic money.

26. Method according to claim 18, comprising the step of using the second code for the identification of an electronic/digital bank note and for the authentication of a numeric transfer of electronic money.

27. Method according to claim 19, comprising the step of using the second code for the identification of an electronic/digital bank note and for the authentication of a numeric transfer of electronic money.

28. Method according to claim 20, comprising the step of using the second code for the identification of an electronic/digital bank note and for the authentication of a numeric transfer of electronic money.

29. Method according to claim 21, comprising the step of using the second code for the identification of an electronic/digital bank note and for the authentication of a numeric transfer of electronic money.

30. Method according to claim 22, comprising the step of using the second code for the identification of an electronic/digital bank note and for the authentication of a numeric transfer of electronic money.

31. An open loop method for transferring fungible electronic money:
two or more Central Banks guaranteeing the electronic money within an
electronic communications network, the electronic money being an authenticated and
fungible currency capable of electronic transfer;
registering a first user within the electronic services network;
registering a second user within the electronic services network;
receiving a request from the first user to transfer at least a portion of the electronic money to the second user;
and electronically transferring the at least a portion of the electronic money to a
mobile device belonging to the second user in response to the request received from the first user, the electronic transfer occurring within the electronic communications network.

32. The method of claim 31, further comprising the steps of:
receiving a request from the second party to convert the at least a portion of the electronic money into banknotes;
sending a message to the mobile device of the second user with a PIN;
and withdrawing the banknotes from an ATM using the PIN.

33. The method of claim 32, wherein the first party and the second party are the same party.

34. The method of claim 31, further comprising the steps of:
validating the request received from the first user;
issuing a voucher to the first user, the voucher containing a PIN;
sending a message from the first user to the mobile device of the second user, the message containing the PIN;
and the second user withdrawing the banknotes from an ATM using the PIN.

35. The method of claim 34, wherein the first party and the second party are the same party.

36. The method of claim 31, wherein two or more Central Banks are in electronic data communication with one another and the electronic communications network so as to track the step of electronically transferring the at least a portion of the electronic money for the purpose of controlling money flow.

37. The method of claim 31, wherein one or more watchdog entities are in electronic data communication with one another and the electronic communications network so as to track the step of electronically transferring the at least a portion of the electronic money for the purpose of preventing abuses.

38. System for carrying out a method for generating fungible electronic money for an open looped system in order to provide fungible electronic money, said method comprising the steps of:
collecting physical and/or numeric parameters of an existing bank note,
using a first algorithm for generating a first code based on at least some of the collected parameters,
using a numbering algorithm for generating an unique code number,
combining the first code with the code number and generating a unique second code which integrates data of the collected parameters,
and attributing the second code to an electronic/digital bank note
Wherein said system comprises:
means for collecting by reading or scanning physical and/or numeric parameters of an existing banknote, a banknote specimen and/or of any numeric data source,
software means in which is stored the first algorithm,
additional software means in which is stored the second algorithm,
and readable and safe means for storing the second code.

39. System according to claim 38, comprising communication means for establishing data communication between official controlling authorities and electronic transaction systems and/or communication/banking networks, for supervising and controlling any transaction using electronic money.
